(19) United States
(12) Patent Application Publication
(10) Pub. No.: US 2025/0315984 A1
(43) Pub. Date: Oct. 9, 2025

(54) ENCODING METHOD, DECODING METHOD, CODE STREAM, ENCODER, DECODER AND STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhuo MA, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/239,382

(22) Filed: Jun. 16, 2025

Related U.S. Application Data
(63) Continuation of application No. PCT/CN2023/071456, filed on Jan. 9, 2023.

(51) Int. Cl. G06T 9/00

(52) U.S. Cl. CPC G06T 9/00

(57) ABSTRACT

Disclosed in embodiments of the present application are an encoding method, a decoding method, a code stream, an encoder, a decoder and a storage medium. At a decoding end, a candidate data processing mode is determined on the basis of a first preset condition, a data processing mode parameter corresponding to a syntax element to be decoded is determined, a target data processing mode is determined according to the data processing mode parameter and on the basis of the candidate data processing mode, said syntax element is decoded according to the target data processing mode, and a value of said syntax element is determined.

### CROSS-REFERENCE TO RELATED APPLICATIONS

This application is a continuation of International Application No. PCT/CN2023/071456, filed on Jan. 9, 2023, the disclosure of which is hereby incorporated by reference in its entirety.

### TECHNICAL FIELD

Embodiments of this application relate to the field of point cloud coding technologies, and in particular, to a coding method, a bitstream, an encoder, a decoder, and a storage medium.

### BACKGROUND

In a coding framework of geometry-based point cloud compression (G-PCC), geometric information of a point cloud and attribute information corresponding to a point in the point cloud are separately encoded. In the G-PCC coding framework, geometry coding mainly includes geometry coding, Trisoup geometry coding, and predictive geometry coding.

In a related technology, both a probability value maintained by an encoder and a mapping relationship look up table are required to be updated. Therefore, in a case in which it cannot be ensured that the probability value maintained by the encoder at any instant increases or decreases monotonically with an index of the encoder, a most matched encoder fails to be selected for encoding in an encoding process, resulting in degrading of coding performance.

### SUMMARY

Embodiments of this application provide a coding method, a bitstream, an encoder, a decoder, and a storage medium, so that a most matched data processing mode can be selected during a coding process, thereby improving coding performance.

Technical solutions in embodiments of this application may be implemented as follows.

According to a first aspect, an embodiment of this application provides a decoding method, applied to a decoder. The method includes:
determining a candidate data processing mode based on a first preset condition;
determining a data processing mode parameter corresponding to a to-be-decoded syntax element;
determining a target data processing mode based on the candidate data processing mode and the data processing mode parameter; and
decoding the to-be-decoded syntax element based on the target data processing mode, to determine a value of the to-be-decoded syntax element.

According to a second aspect, an embodiment of this application provides an encoding method, applied to an encoder. The method includes:
determining a candidate data processing mode based on a first preset condition;
determining a data processing mode parameter corresponding to a to-be-encoded syntax element;
determining a target data processing mode based on the candidate data processing mode and the data processing mode parameter; and
encoding a value of the to-be-encoded syntax element based on the target data processing mode to obtain encoded bits, and writing the encoded bits into a bitstream.

According to a third aspect, an embodiment of this application provides a bitstream, where the bitstream is generated by performing bit encoding on information to be encoded, and the information to be encoded at least includes a value of a to-be-encoded syntax element.

According to a fourth aspect, an embodiment of this application provides an encoder. The encoder includes a first determining unit and an encoding unit, where
the first determining unit is configured to determine a candidate data processing mode based on a first preset condition; and determine a data processing mode parameter corresponding to a to-be-encoded syntax element;
the first determining unit is further configured to determine a target data processing mode based on the candidate data processing mode and the data processing mode parameter; and
the encoding unit is configured to encode a value of the to-be-encoded syntax element based on the target data processing mode to obtain encoded bits, and write the encoded bits into a bitstream.

According to a fifth aspect, an embodiment of this application provides an encoder. The encoder includes a first memory and a first processor, where
the first memory is configured to store a computer program runnable on the first processor; and
the first processor is configured to run the computer program to execute the method according to the second aspect.

According to a sixth aspect, an embodiment of this application provides a decoder. The decoder includes a second determining unit and a decoding unit, where
the second determining unit is configured to determine a candidate data processing mode based on a first preset condition, and determine a data processing mode parameter corresponding to a to-be-decoded syntax element;
the second determining unit is further configured to determine a target data processing mode based on the candidate data processing mode and the data processing mode parameter; and
the decoding unit is configured to decode the to-be-decoded syntax element based on the target data processing mode, to determine a value of the to-be-decoded syntax element.

According to a seventh aspect, an embodiment of this application provides a decoder. The decoder includes a second memory and a second processor, where
the second memory is configured to store a computer program runnable on the second processor; and
the second processor is configured to run the computer program to execute the method according to the first aspect.

According to an eighth aspect, an embodiment of this application provides a computer-readable storage medium, where the computer-readable storage medium stores a computer program, and the computer program is executed to implement the method according to the first aspect, or the method according to the second aspect.

Embodiments of this application provide a coding method, a bitstream, an encoder, a decoder, and a storage medium. On an encoding side, a candidate data processing mode is determined based on a first preset condition; a data processing mode parameter corresponding to a to-be-encoded syntax element is determined; a target data processing mode is determined based on the candidate data processing mode and the data processing mode parameter; and a value of the to-be-encoded syntax element is encoded based on the target data processing mode to obtain encoded bits, and the encoded bits are written into a bitstream. On a decoding side, a candidate data processing mode is determined based on a first preset condition; a data processing mode parameter corresponding to a to-be-decoded syntax element is determined; a target data processing mode is determined based on the candidate data processing mode and the data processing mode parameter; and the to-be-decoded syntax element is decoded based on the target data processing mode, to determine a value of the to-be-decoded syntax element. It may be learned that in embodiments of this application, a corresponding data processing mode parameter may be determined based on a to-be-processed syntax element, and a target data processing mode may be further determined from candidate data processing modes, and finally, the syntax element may be encoded or decoded based on the target data processing mode.

### BRIEF DESCRIPTION OF DRAWINGS

FIG. 1 is a schematic diagram of a network architecture of point cloud coding.

FIG. 2 is a schematic diagram of a framework of a G-PCC encoder.

FIG. 3 is a schematic diagram of a framework of a G-PCC decoder.

FIG. 4 is a schematic flowchart of mapping of a discrete state D.

FIG. 5 is a schematic flowchart of dynamic mapping of a discrete state D.

FIG. 6A to FIG. 6H show a spatial location relationship of a point cloud.

FIG. 7 is a schematic diagram of scanning order of child nodes.

FIG. 8 is a schematic diagram of an implementation method for dynamic reduction.

FIG. 9 is a schematic diagram of an implementation method for dynamic reduction update.

FIG. 10 is a schematic flowchart of a decoding method according to an embodiment of this application.

FIG. 11 is a schematic diagram 1 of implementation of a dynamic adjustment scheme according to this application.

FIG. 12 is a schematic flowchart of an encoding method according to an embodiment of this application.

FIG. 13 is a schematic diagram 2 of implementation of a dynamic adjustment scheme according to this application.

FIG. 14 is a schematic diagram of a structure of an encoder according to an embodiment of this application.

FIG. 15 is a schematic diagram of a specific hardware structure of an encoder according to an embodiment of this application.

FIG. 16 is a schematic diagram of a structure of a decoder according to an embodiment of this application.

FIG. 17 is a schematic diagram of a specific hardware structure of a decoder according to an embodiment of this application.

FIG. 18 is a schematic diagram of a structure of a coding system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, there are “some embodiments” that describe a subset of all possible embodiments, but it may be understood that “some embodiments” may be the same subset or different subsets of all possible embodiments and may be combined with each other in the case of no conflicts. It should also be noted that the term “first/second/third” used in embodiments of this application is merely used to distinguish between similar objects and does not represent a specific order of objects. It may be understood that “first/second/third” may be interchanged in a specific order or sequence if allowed, so that the embodiments of this application described herein may be implemented in a sequence other than the sequence illustrated or described herein.

The nouns and terms used in embodiments of this application are described before providing a more detailed description of embodiments of this application, and the nouns and terms used in embodiments of this application are applicable to the following explanations:
point cloud compression (PCC);
geometry-based point cloud compression (G-PCC or GPCC)
video-based point cloud compression (V-PCC or VPCC);
octree (Octree);
triangle soup (Trisoup);
intra prediction (Intra Prediction);
look up table (LUT);
red-green-blue (RGB);
luminance-chrominance (YUV);
level of detail (LOD);
predicting transform (Predicting Transform);
lifting transform (Lifting Transform);
region adaptive hierarchal transform (RAHT); and
context-based adaptive binary arithmetic coding (CABAC).

It may be understood that a point cloud (Point Cloud) is a three-dimensional representation of a surface of an object. A point cloud (data) of a surface of an object may be collected by using a collection device such as an optoelectronic radar, a LIDAR, a laser scanner, or a multi-view camera.

In addition, the point cloud is a set of a massive quantity of three-dimensional points, and a point in the point cloud may include location information and attribute information of the point. For example, the location information of the point may be three-dimensional coordinate information of the point. The location information of the point may also be referred to as geometric information of the point. For example, the attribute information of the point may include color information, reflectivity, and/or the like. For example, the color information may be information in any color space. For example, the color information may be RGB information. R denotes red (Red, R), G denotes green (Green, G), and B denotes blue (Blue, B). For another example, the color information may be luminance-chrominance (YCbCr, YUV) information. Y denotes luma, Cb (U) denotes blue chroma, and Cr (V) denotes red chroma.

A point in a point cloud obtained according to a laser measurement principle may include three-dimensional coordinate information of the point and laser reflectance of the point. For another example, a point in a point cloud obtained according to a photography measurement principle may include three-dimensional coordinate information of the point and color information of the point. For another example, a point in a point cloud obtained according to a laser measurement principle in combination with a photography measurement principle may include three-dimensional coordinate information of the point, laser reflectance of the point, and color information of the point.

Point clouds may be classified into the following three types according to acquisition methods.
Type 1: static point cloud, where an object is stationary, and a device for acquiring the point cloud is also stationary.
Type 2: dynamic point cloud, where an object is moving, while a device for acquiring the point cloud is stationary.
Type 3: dynamically acquired point cloud, where a device for acquiring the point cloud is moving.

For example, point clouds are classified into the following two types according to their usage.
Type 1: machine perception point cloud, which may be used in a scenario such as an autonomous navigation system, a real-time inspection system, a geographic information system, a visual sorting robot, or a disaster relief robot.
Type 2: human eye perception point cloud, which may be used in a point cloud application scenario such as digital cultural heritage, free viewpoint broadcasting, three-dimensional immersion communication, or three-dimensional immersion interaction.

Since a point cloud is a set of a massive quantity of points, storing the point cloud consumes a large amount of memory, and is not convenient for transmission. Moreover, there is no such a large bandwidth to support direct transmission of the point cloud at a network layer without compression. Therefore, it is necessary to compress the point cloud.

To date, a point cloud encoding framework used for compressing a point cloud may be a G-PCC coding framework or a V-PCC coding framework provided by the Moving Picture Experts Group (MPEG), or may be an AVS-PCC coding framework provided by the Audio Video Standard (AVS). The G-PCC coding framework may be used to compress the static point cloud of type 1 and the dynamically acquired point cloud of type 3, and the V-PCC coding framework may be used to compress the dynamic point cloud of type 2. The G-PCC coding framework is mainly described in embodiments of this application.

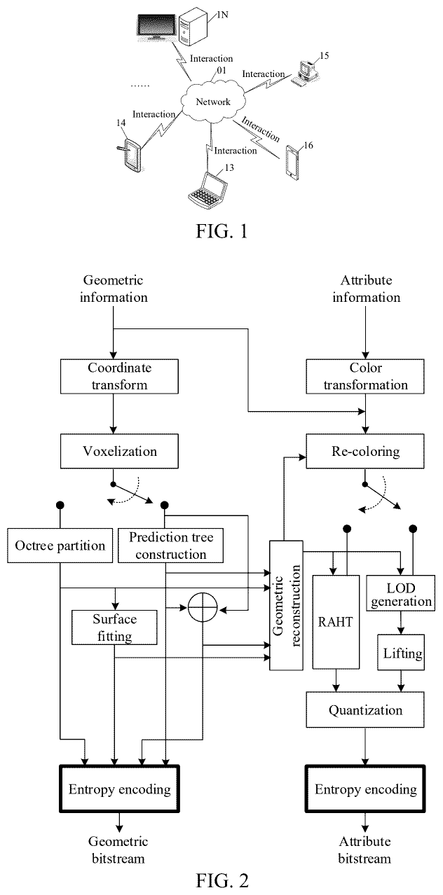

Embodiments of this application provide a network architecture of a point cloud coding system involving in a decoding method and an encoding method. FIG. 1 is a schematic diagram of a network architecture of point cloud coding according to an embodiment of this application. As shown in FIG. 1, the network architecture includes one or more electronic devices 13 to 1N and a communication network 01. The electronic devices 13 to 1N may perform video interaction with each other through the communication network 01. The electronic devices may be implemented as various types of devices having a point cloud coding function. For example, the electronic devices may include a mobile phone, a tablet computer, a personal computer, a personal digital assistant, a navigator, a digital phone, a videophone, a television, a sensing device, a server, and the like, which is not limited in embodiments of this application. The decoder or the encoder in embodiments of this application may be the electronic device described above.

The electronic device in embodiments of this application has a point cloud coding function, and generally includes a point cloud encoder (that is, an encoder) and a point cloud decoder (that is, a decoder).

A related technology is described below using the G-PCC coding framework as an example.

It may be understood that, in a point cloud G-PCC coding framework, point cloud data to be encoded is first partitioned into a plurality of slices. In each slice, geometric information of each point cloud and attribute information corresponding to the point cloud are separately encoded.

FIG. 2 is a schematic diagram of a framework of a G-PCC encoder. As shown in FIG. 2, in a geometry encoding process, geometric information is subjected to coordinate transformation, such that the whole point cloud is contained within a bounding box, and the geometric information is then subjected to quantization. The quantization is performed to realize a scaling function. Due to rounding during quantization, a part of the point cloud has identical geometric information. Then, it is determined whether to remove duplicate points based on a parameter. The process of quantization and removal of duplicate points is also referred to as a voxelization process. Next, octree partitioning or prediction tree construction is performed on the bounding box. In this process, arithmetic encoding is performed on a point in a leaf node subjected to partitioning, to generate a binary geometric bitstream. Alternatively, arithmetic encoding (surface fitting is performed based on a vertex) is performed on a vertex generated by partitioning, to generate a binary geometric bitstream. In an attribute encoding process, geometry encoding is completed. After geometric information is reconstructed, it is necessary to first perform color transformation on the geometric information to convert color information (that is, attribute information) from RGB color space to YUV color space. Then, the point cloud is re-colored by using the reconstructed geometric information, so that attribute information that is not encoded corresponds to the reconstructed geometric information. Attribute encoding is mainly performed on color information. In a color information encoding process, there are mainly two transformation methods: One method is distance-based lifting transform depending on LOD partitioning, and the other method is to directly perform RAHT. In both the two methods, the color information is transformed from a spatial domain to a frequency domain, a high-frequency coefficient and a low-frequency coefficient are obtained by transformation, the high-frequency coefficient and the low-frequency coefficient are quantized, and then arithmetic encoding is performed on the quantized coefficients, to generate a binary attribute bitstream.

FIG. 3 is a schematic diagram of a framework of a G-PCC decoder. As shown in FIG. 3, for an acquired binary bitstream, a geometric bitstream and an attribute bitstream in the binary bitstream are first decoded separately. During decoding of the geometric bitstream, geometric information of the point cloud is obtained by arithmetic decoding-octree reconstruction/prediction tree reconstruction-geometry reconstruction-inverse coordinate transform. During decoding of the attribute bitstream, attribute information of the point cloud is obtained by arithmetic decoding-dequantization-LOD partitioning/RAHT-color inverse transform, and the to-be-encoded point cloud data (that is, an output point cloud) is restored based on the geometric information and the attribute information.

The octree geometry encoding (OctGeomEnc) includes the following steps. First, coordinate transformation is performed on the geometric information, such that the whole point cloud is contained within a bounding box. Then, quantization is performed. The quantization is performed to realize a scaling function. Due to rounding during quantization, some points have identical geometric information. It is then determined whether to remove duplicate points based on a parameter. The process of quantization and removal of duplicate points is also referred to as a voxelization process. Next, tree partition (for example, an octree, a quadtree, or a binary tree) is performed on the bounding box continuously in breadth-first traversal order. For a child node generated by partitioning, one bit is used to indicate whether a cuboid block corresponding to the node in space contains a point, which is referred to as a “placeholder code”. A placeholder code of each node is encoded. In the octree geometry encoding framework, the bounding box is sequentially partitioned to obtain child nodes, and child nodes that are not empty (containing a point in the point cloud) are partitioned until a leaf node obtained becomes a unit cube of 1×1×1. Then, points contained in the leaf node are encoded, to finally complete the encoding of the geometry octree, to generate a binary bitstream. In a triangle soup geometry encoding framework, it is also necessary to perform octree partitioning. However, different from octree geometric information encoding, it is unnecessary to partition the point cloud level by level into a unit cube with a side length of 1×1×1 in this method. Instead, partitioning stops when a side length of a block is W. Based on a surface formed by distribution of the point cloud in each block, a maximum of twelve vertices (Vertex) are formed by the surface and twelve sides of the block. Vertex coordinates of respective blocks are sequentially encoded to generate a binary bitstream.

For octree geometry decoding, on a decoding side, parsing is continuously performed in breadth-first traversal order to obtain a placeholder code of each node, and nodes are sequentially partitioned continuously until a unit cube of 1×1×1 is obtained. Then, parsing is performed to obtain a quantity of points included in each leaf node, and finally geometric reconstruction point cloud information is restored.

The Trisoup geometry encoding includes the following steps. First, octree partitioning is performed. Different from the octree geometric information encoding, it is unnecessary to partition the point cloud level by level into bottom-layer leaf nodes with side lengths of 1×1×1 in this method, and the point cloud is partitioned into leaf nodes with a specified side length. Then, surface information formed by voxels in the nodes is represented by a series of triangle meshes. In GPCC, a parameter trisoup node size is used to represent a size of a block in which a triangular mesh is located. When the trisoup node size is greater than 0, a voxel set in a node is represented by using a geometric mesh, and at most twelve vertices generated by a geometric mesh and twelve edges of the block are referred to as vertices (Vertex). Vertex coordinates of respective blocks are sequentially encoded to generate a binary bitstream.

The Trisoup geometry decoding includes the following step. To decode geometric coordinates of the point cloud from the triangular mesh of the node, it is necessary to check whether each voxel in the node cube intersects with the triangular mesh. This technique is called triangular rasterization, that is, intersection tests are performed using six unit vectors (0, 0, 1), (0, 0, 1), (0, 0, 1), (0, 0, 1), (0, 0, 1), and (0, 0, 1), to determine whether respective unit vectors intersect with the triangular mesh. If a determination result is positive, an intersection point is calculated and a decoded cube is output. A quantity of points generated in the decoder is determined by a mesh distance d.

Predictive geometry encoding (Predictive geometry coding, PredGeomTree) includes: sorting input point clouds first, where sorting methods currently used include disordering, Morton ordering, azimuth ordering, and radial distance ordering. On an encoding side, a prediction tree structure is established in two different modes: high-latency slow mode (KD-Tree, KD tree) and low-latency fast mode (points are assigned to different lasers (Laser) by using LIDAR calibration information, and a prediction tree structure is established based on different lasers). Next, based on the prediction tree structure, all nodes in the prediction tree are traversed, geometric location information of the node is predicted by selecting different prediction modes to obtain a geometric prediction residual, and the geometric prediction residual is quantized by using a quantization parameter. Finally, the prediction residual of the location information of the node in the prediction tree, the prediction tree structure, the quantization parameter, and the like are encoded by continuous iteration, to generate a binary bitstream.

For predictive geometry decoding, a prediction tree structure is reconstructed on the decoding side by continuously parsing bitstreams. Then, prediction residual information of geometric locations of respective prediction nodes and quantization parameters are obtained through parsing, and dequantization is performed on the prediction residual to restore reconstructed geometric location information of respective nodes, thereby completing geometric reconstruction on the decoding side.

In an implementation, a series of discrete states D of a placeholder code may be quickly and accurately mapped to a fixed quantity N of adaptive entropy encoders through a mapping relationship look up table (LUT). In this way, there is no longer a one-to-one correspondence between a context information state and a probability model. Instead, the fixed quantity of probability models are updated with syntax elements being currently encoded. Furthermore, the mapping relationship is updated each time when a placeholder code is encoded.

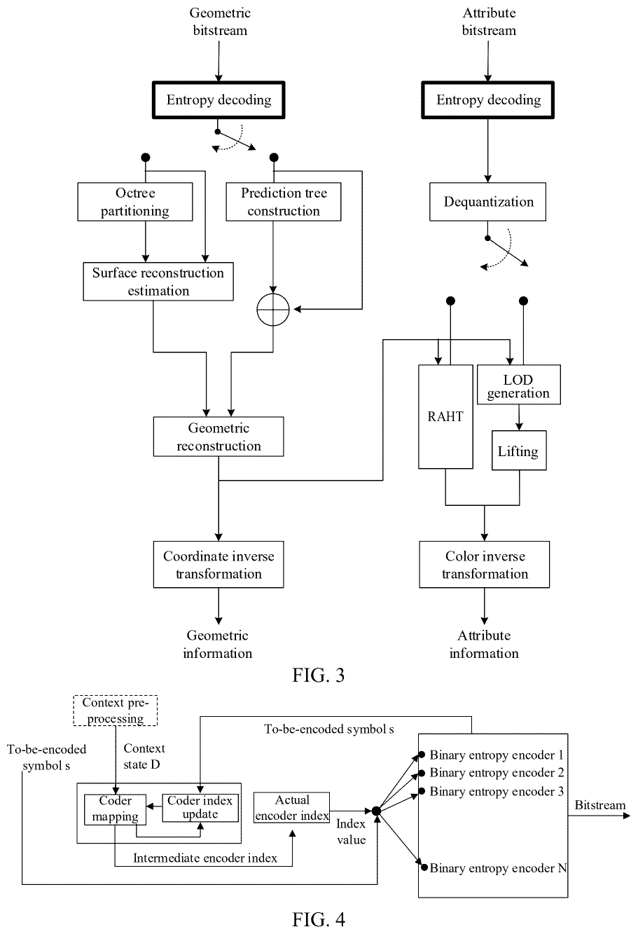

FIG. 4 is a schematic flowchart of mapping of a discrete state D. As shown in FIG. 4, an index value of the encoder that is obtained after mapping is [0, 1, . . . , N−1], and the symbol s denotes an occupancy bit to be encoded or decoded, with a value of 1 or 0.

In the process of implementing coding through the mapping of the discrete state D, a context state D of a to-be-encoded symbol may be first acquired. The context state D of the to-be-encoded symbol is input information to the mapping process of the discrete state D, and is composed of information about an encoded neighboring node in space and a location of a child node relative to a parent node.

After the context state D of the to-be-encoded symbol is acquired, an index value i of a binary encoder corresponding to the state D may be further obtained based on the mapping relationship (the mapping relationship look up table).

Before all to-be-encoded symbols (occupancy information of all nodes) are encoded, each state may be preset to correspond to a value ranging from 0 to 255. This value serves as an index of a binary encoder. Each state is mapped to a corresponding binary encoder based on a state value of the state. Each of the 256 binary encoders has an associated probability pᵢ∈(0,1), and a value of the associated probability pᵢ increases as the index i increases. The associated probability of each binary encoder remains unchanged during the encoding process.

The technique of mapping the discrete state D may include two LUTs: an LUT 0 and an LUT 1. When a to-be-encoded bit s is 0, the encoder index is updated in the LUT 0. When a to-be-encoded bit s is 1, an intermediate encoder index (with a value of [0, 1, . . . , 255]) is updated in the LUT 1. The 256 intermediate index values are mapped to final 32 actual coders (that is, [0, 1, . . . , 31]).

An index value may be updated according to the following formula, to determine an updated encoder index i_{update}:

$${i}_{update} = \{ \begin{matrix}LUT 0 & s = 0 \\ LUT 1 & s = 1\end{matrix} \qquad ( 1 )$$

During generation of the mapping relationship look up table LUT, probability values pᵢ(i∈[0, 1, . . . , 255]) associated with the 256 binary encoders may be first generated according to the following entropy error (entropy error) formulas and an error threshold ε.

$$\begin{matrix}E ( p , {p}_{i} ) = {p}_{i} [ - {log}_{2} ( p ) + {log}_{2} ( {p}_{i} ) ] + ( 1 - {p}_{i} ) [ - {log}_{2} ( 1 - p ) + {log}_{2} ( 1 - {p}_{i} ) ] & ( 2 ) \\ {p}_{i + 1} = min \{ p \vert E ( p , {p}_{i} ) \leq ɛ \& p \geq {p}_{i} \} & ( 3 )\end{matrix}$$

A memory channel L may be set as follows: (L=max(5, 1/p, 1/(1−p)) and clipped to 200), and an actual updated probability value p_{new} corresponding to each symbol s subjected to encoding may be calculated according to the following formula:

$${p}_{new} = ( L \times {p}_{i} + s ) / ( L + 1 ) \qquad ( 4 )$$

Finally, a probability value with a minimum entropy error relative to the actual probability value p_{new} may be determined from the generated 256 theoretically associated probability values, according to the following formula, to obtain a corresponding number i∈[0, 1, . . . , 255], that is, an (intermediate) encoder index i_{update} corresponding to the current symbol.

$${i}_{update} = arg {min}_{i} \vert {p}_{i} , {p}_{new} \vert \qquad ( 5 )$$

The formula (2) may be applied to each probability in an associated probability table. Then, based on whether a to-be-encoded symbol is 0 or 1, an updated probability value may be calculated and a corresponding index value i_{update} may be obtained. These values are stored in the LUT 0 or the LUT 1, to obtain mapping relationship look up tables (LUTs).

Further, after a binary encoder i corresponding to the state D is obtained based on the mapping relationship, the binary encoder i may be used to perform entropy encoding on the symbol s. The to-be-encoded symbol s and its corresponding context state D may be input into a context-based binary arithmetic encoder for entropy encoding.

As shown in FIG. 4, during the mapping of the discrete state D, an intermediate encoder index may be first determined using the mapping relationship look up table LUT based on a to-be-encoded symbol s (occupancy information) of a current point and a corresponding context state D. An actual encoder index may be then determined. Finally, the to-be-encoded symbol is encoded using an encoder corresponding to the actual encoder index, to generate a corresponding binary bitstream. After the encoding of the to-be-encoded symbol of the current point is completed, the mapping relationship look up table LUT may be further updated based on the to-be-encoded symbol.

It should be noted that the look up table used (that is, the mapping relationship look up table LUT) may be further simplified. Specifically, the LUT 0 and the LUT 1 may be first merged according to the following formula:

$$LUT 1 [ s ] = 255 - LUT 0 [ 255 - s ] \qquad ( 6 )$$

Then, the LUT is converted into a ΔLUT jump table based on a relationship between an index stored in the LUT and its position.

$$Δ LUT [ i ] = i - LUT 0 [ i ] \qquad ( 7 )$$

Moreover, the 256 jump values in the ΔLUT may be grouped, where each group contains 16 jump values. For example, a final jump table obtained may be as shown in Table 1. The index value is then updated according to the following formula. Finally, a secondary mapping process is added, that is, a binary encoder index value i_{update} obtained is used as an intermediate value (ranging from 0 to 255), and the intermediate value is mapped to a binary encoder index value ranging from 0 to 31. The secondary mapping may be a simple operation of dividing the intermediate value by 8 and rounding a dividing result down. However, each state D still corresponds to a value ranging from 0 to 255, and there are still 256 associated probabilities.

$${i}_{update} = \{ \begin{matrix}i - Δ LUT [ ( 255 - i ) >> 4 ] & s = 0 \\ i + Δ LUT [ ( 255 - i ) >> 4 ] & s = 1\end{matrix} \qquad ( 8 )$$

TABLE 1
Jump table ΔLUT

| | i | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| Value | 0 | 1 | 1 | 2 | 4 | 7 | 9 | 11 | 14 | 16 | 19 | 23 | 22 | 22 | 20 | 15 |

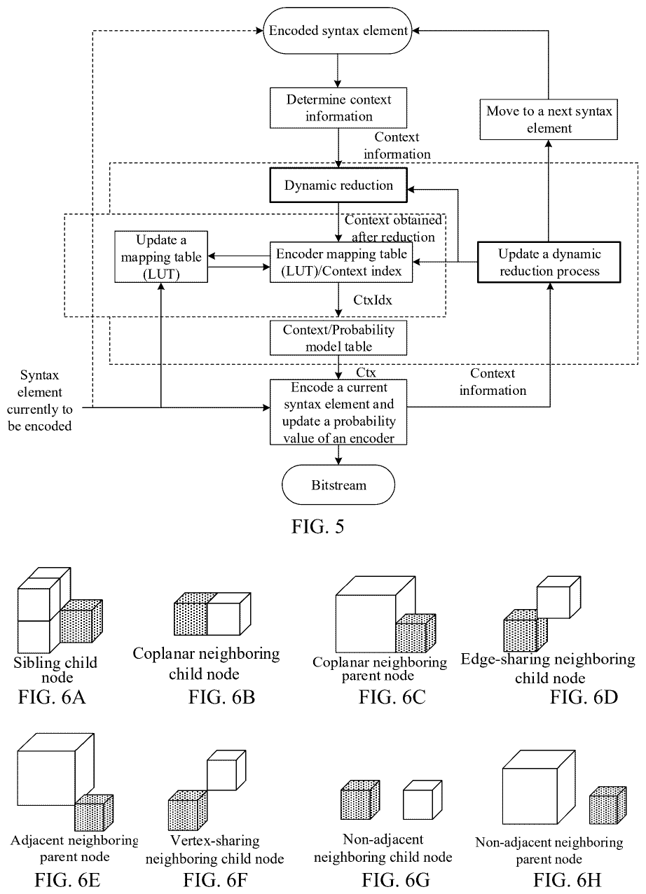

It may be understood that, a technique of dynamically mapping the discrete state D is provided. FIG. 5 is a schematic flowchart of dynamic mapping of a discrete state D. As shown in FIG. 5, the technique of dynamically mapping the discrete state D may include two stages. Stage 1: Context information (a context state) of an occupancy code to be encoded is acquired and reduced, and information required to be reduced each time is dynamically adjusted during an encoding process. Stage 2: The reduced context information is mapped to a relatively small quantity of binary encoder sets, and the mapping relationship is updated each time when encoding of an occupancy code is completed.

The determination and update of the mapping relationship in stage 2 are the same as those in common techniques of mapping the discrete state D.

For the technique of dynamically mapping the discrete state D, in the context (context state) construction and dynamic reduction process in Stage 1, the context information is composed of an encoded syntax element. The information may be classified into primary information and secondary information depending on its importance. Some information in the secondary information is reduced in the dynamic reduction process, and a context obtained by combining the primary information and the secondary information subjected to reducing is used as input of the mapping process of the discrete state D, and is mapped to the encoder for encoding.

In the context state information construction process, a context of a to-be-encoded child node may be determined based on the following types of information:
(1) local sparsity of the to-be-encoded child node;
(2) location information of the to-be-encoded child node and an occupancy status of an encoded sibling node;
(3) an occupancy status of six coplanar parent neighbors of a current node;
(4) an occupancy status of other 20 edge-sharing and vertex-sharing parent neighbors of the current node.

The context information may be converted into a binary stream (bins), where information more relevant to the current child node is located in a higher-order bit of the bins as primary information, and information less relevant to the current child node is located in a lower-order bit of the bins as secondary information.

In some embodiments, FIG. 6A to FIG. 6H show a spatial location relationship of a point cloud. As shown in FIG. 6A to FIG. 6H, for a current child node, spatial reference points may at least include: an encoded sibling node of the current child node, an encoded coplanar neighboring child node of the current child node, an encoded edge-sharing neighboring child node of the current child node, an encoded vertex-sharing neighboring child node of the current child node, other encoded neighboring child nodes of the current child node, an encoded coplanar neighboring parent node of the current child node, an encoded edge-sharing neighboring parent node of the current child node, and other twenty encoded neighboring parent nodes of the current child node. These contexts are ranked according to importance in the following order: the encoded sibling node of the current child node>the encoded coplanar neighboring child node of the current child node>the encoded edge-sharing neighboring child node of the current child node>the encoded vertex-sharing neighboring child node of the current child node>other encoded neighboring child nodes of the current child node>the encoded coplanar neighboring parent node of the current child node>the encoded edge-sharing neighboring parent node of the current child node>other twenty encoded neighboring parent nodes of the current child node.

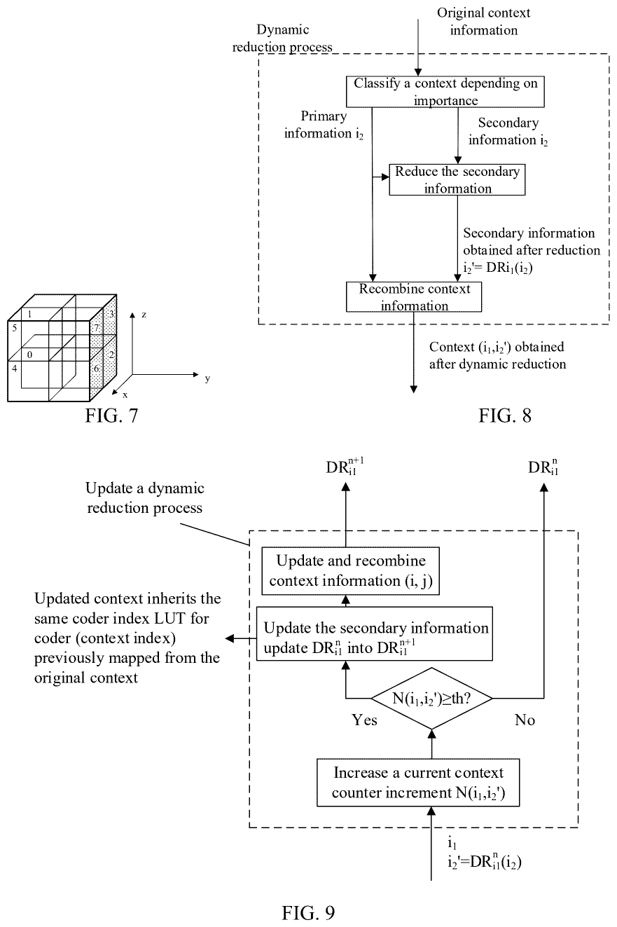

It should be noted that, in embodiments of this application, FIG. 7 is a schematic diagram of scanning order of child nodes. As shown in FIG. 7, during construction of context information, different context models may be first constructed in scanning order for to-be-encoded child nodes located at different locations of the current node. As a quantity of encoded child nodes in the current node increases, valid context information that may be referenced by an unencoded child node also changes. In addition, local sparsity of the eight child nodes of the current node is determined by using different methods, so that each child node has its own context bins.

Further, FIG. 8 is a schematic diagram of an implementation method for dynamic reduction. As shown in FIG. 8, in a dynamic reduction and dynamic reduction update process, after original context information bins (i₁, i₂) is classified into primary information i₁ and secondary information i₂, only the secondary information i₂ is reduced, that is, k bits of i₂ are set to 0 (clipped) to obtain secondary information. Then, the context is recombined to form a context state D(i₁,i₂), that is, a context after dynamic reduction is determined.

FIG. 9 is a schematic diagram of an implementation method for dynamic reduction update. As shown in FIG. 9, for each context state D, a counter N(i₁,i₂) is provided to record a quantity of times a current state D has been accessed. In the process of implementing dynamic reduction, if N(i₁,i₂) is greater than a set threshold th, (k−1)-bit secondary information is deleted from the original context bins instead of deleting k-bit secondary information, the context is recombined, and a new state D(i₁,i₂) is activated, that is, more secondary information forms a new context state for a syntax element to be encoded subsequently, which indicates that secondary information to be reduced is dynamically adjusted.

In some embodiments, during selection of an encoder based on a determined index value, the encoder index mapping relationship look up table provides a mapping relationship between a context state and an encoder index. Based on the mapping relationship look up table, an encoder index that should be used by a to-be-encoded syntax element in any context state may be obtained. After one syntax element is encoded each time, the mapping relationship between a context state D and an encoder index in the mapping relationship look up table is adjusted based on an encoding result of the syntax element.

In GPCC, 8-bit encoder indexes may be stored in the encoder index mapping relationship look up table. When a symbol currently to be encoded is “1”, the encoder index increases (or remains unchanged). When a symbol currently to be encoded is “0”, the encoder index decreases (or remains unchanged).

In some embodiments, a probability of an encoder may be updated as follows. When a binary syntax element is encoded, a probability value of the encoder is updated. If the probability value of the encoder represents a probability of the symbol “0”, when a binary syntax element currently to be encoded is 0, the probability value of the encoder increases (or remains unchanged); or when a binary syntax element currently to be encoded is 1, the probability value of the encoder decreases (or remains unchanged). If the probability value of the encoder represents a probability of the symbol “1”, when a binary syntax element currently to be encoded is 0, the probability value of the encoder decreases (or remains unchanged); or when a binary syntax element currently to be encoded is 0, the probability value of the encoder increases (or remains unchanged).

In GPCC, a probability value of an encoder represents a probability of the symbol “0”, the probability value of the encoder increases (or remains unchanged) after the symbol “0” is encoded, and the probability value of the encoder decreases (or remains unchanged) after the symbol “1” is encoded. The updating is performed according to the following formula:

$${p}_{new} ( 0 ) = \{ \begin{matrix}1 - α \times ( 1 - {p}_{old} ( 0 ) ) & binVal = 0 \\ α \times {p}_{old} ( 0 ) & binVal = 1\end{matrix} \qquad ( 9 )$$

In which, binVal denotes a symbol to be encoded, p_{old}(0) and p_{new}(0) respectively denote probability values of the symbol “0” that are stored before and after encoder update, and α denotes an attenuation factor. In practical implementation, a look up table may be used.

Assuming that the encoder probability is represented with 16-bit precision, a formula (9) may be approximately converted into a formula (10).

$${p}_{new} ( 0 ) = \{ \begin{matrix}{p}_{old} ( 0 ) + diracLut [ 255 - ( {p}_{old} ( 0 ) >> 8 ) ] & binVal = 0 \\ {p}_{old} ( 0 ) - diracLut [ {p}_{old} ( 0 ) >> 8 ] & binVal = 1\end{matrix} \qquad ( 10 )$$

In which, diracLut denotes a look up table, as shown in Table 2.

TABLE 2
diracLut [i + j] values

| | i | | | | | | | | | | | |
|---|---|---|---|---|---|---|---|---|---|---|---|---|
| j | 0 | 1 | 2 | 3 | 4 | 5 | 6 | 7 | 8 | 9 | 10 | 11 |
| 0 | 0 | 2 | 5 | 8 | 11 | 15 | 20 | 24 | 29 | 35 | 41 | 47 |
| 12 | 53 | 60 | 67 | 74 | 82 | 89 | 97 | 106 | 114 | 123 | 132 | 141 |
| 24 | 150 | 160 | 170 | 180 | 190 | 201 | 211 | 222 | 233 | 244 | 256 | 267 |
| 36 | 279 | 291 | 303 | 315 | 327 | 340 | 353 | 366 | 379 | 392 | 405 | 419 |
| 48 | 433 | 447 | 461 | 475 | 489 | 504 | 518 | 533 | 548 | 563 | 578 | 593 |
| 60 | 609 | 624 | 640 | 656 | 672 | 688 | 705 | 721 | 738 | 754 | 771 | 788 |
| 72 | 805 | 822 | 840 | 857 | 875 | 892 | 910 | 928 | 946 | 964 | 983 | 1001 |
| 84 | 1020 | 1038 | 1057 | 1076 | 1095 | 1114 | 1133 | 1153 | 1172 | 1192 | 1211 | 1231 |
| 96 | 1251 | 1271 | 1291 | 1311 | 1332 | 1352 | 1373 | 1393 | 1414 | 1435 | 1456 | 1477 |
| 108 | 1498 | 1520 | 1541 | 1562 | 1584 | 1606 | 1628 | 1649 | 1671 | 1694 | 1716 | 1738 |
| 120 | 1760 | 1783 | 1806 | 1828 | 1851 | 1874 | 1897 | 1920 | 1935 | 1942 | 1949 | 1955 |
| 132 | 1961 | 1968 | 1974 | 1980 | 1985 | 1991 | 1996 | 2001 | 2006 | 2011 | 2016 | 2021 |
| 144 | 2025 | 2029 | 2033 | 2037 | 2040 | 2044 | 2047 | 2050 | 2053 | 2056 | 2058 | 2061 |
| 156 | 2063 | 2065 | 2066 | 2068 | 2069 | 2070 | 2071 | 2072 | 2072 | 2072 | 2072 | 2072 |
| 168 | 2072 | 2071 | 2070 | 2069 | 2068 | 2066 | 2065 | 2063 | 2060 | 2058 | 2055 | 2052 |
| 180 | 2049 | 2045 | 2042 | 2038 | 2033 | 2029 | 2024 | 2019 | 2013 | 2008 | 2002 | 1996 |
| 192 | 1989 | 1982 | 1975 | 1968 | 1960 | 1952 | 1943 | 1934 | 1925 | 1916 | 1906 | 1896 |
| 204 | 1885 | 1874 | 1863 | 1851 | 1839 | 1827 | 1814 | 1800 | 1786 | 1772 | 1757 | 1742 |
| 216 | 1727 | 1710 | 1694 | 1676 | 1659 | 1640 | 1622 | 1602 | 1582 | 1561 | 1540 | 1518 |
| 228 | 1495 | 1471 | 1447 | 1422 | 1396 | 1369 | 1341 | 1312 | 1282 | 1251 | 1219 | 1186 |
| 240 | 1151 | 1114 | 1077 | 1037 | 995 | 952 | 906 | 857 | 805 | 750 | 690 | 625 |
| 252 | 553 | 471 | 376 | 255 | | | | | | | | |

A value of i+j may range from 0 to 255.

It may be understood that, the mapping relationship look up table is updated to search for an encoder that is closer to a probability for a current context state. In a related technology, it is assumed that a probability value maintained by the encoder increases or decreases monotonically with an encoder index. However, in an encoding process, since both a probability value maintained by an encoder and a mapping relationship look up table are required to be updated, and in a probability value update process, probability values maintained by different encoders may overlap and/or the probability values change excessively. As a result, it cannot be ensured that the probability value maintained by the encoder at different instants increases or decreases monotonically with an index of the encoder.

It may be learned that, in a common point cloud coding technology, since both a probability value maintained by an encoder and a mapping relationship look up table are required to be updated, it cannot be ensured that the probability value maintained by the encoder at different instants increases or decreases monotonically with an index of the encoder, a most matched encoder fails to be selected for encoding in an encoding process, resulting in reducing of the coding performance.

To resolve the foregoing problem, in embodiments of this application, on an encoding side, a candidate data processing mode is determined based on a first preset condition; a data processing mode parameter corresponding to a to-be-encoded syntax element is determined; a target data processing mode is determined based on the candidate data processing mode and the data processing mode parameter; and a value of the to-be-encoded syntax element is encoded based on the target data processing mode to obtain encoded bits, and the encoded bits are written into a bitstream. On a decoding side, a candidate data processing mode is determined based on a first preset condition; a data processing mode parameter corresponding to a to-be-decoded syntax element is determined; a target data processing mode is determined based on the candidate data processing mode and the data processing mode parameter; and the to-be-decoded syntax element is decoded based on the target data processing mode, to determine a value of the to-be-decoded syntax element. It may be learned that in embodiments of this application, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

The point cloud encoding method in embodiments of this application may be applied to the entropy encoding portion shown in FIG. 2. In addition, the point cloud decoding method in embodiments of this application may be applied to the entropy decoding portion shown in FIG. 3. That is, the point cloud encoding and decoding methods in embodiments of this application may be applied to either an encoder or a decoder, or may even be applied to both an encoder and a decoder. However, embodiments of this application set no specific limitation thereto.

The following describes embodiments of this application in detail with reference to the drawings.

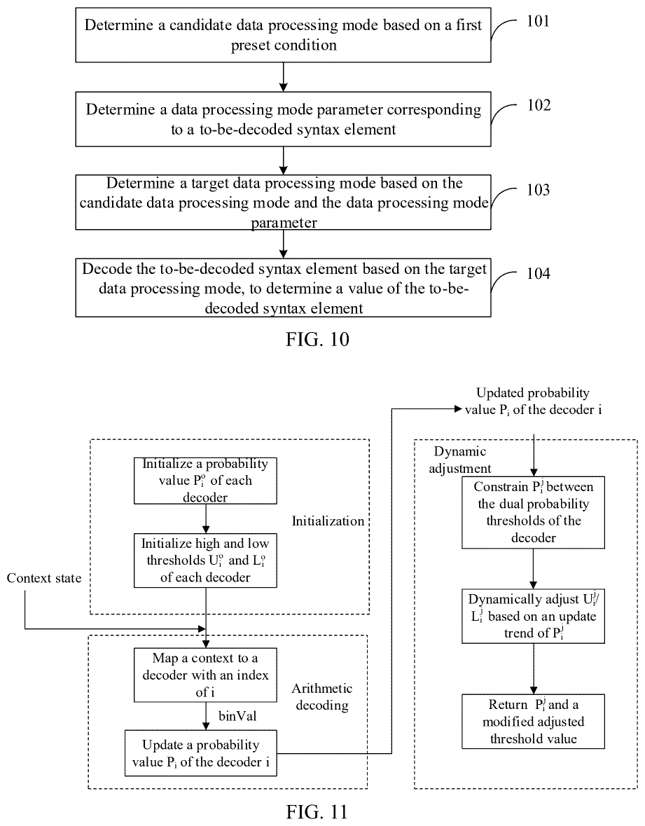

FIG. 10 is a schematic flowchart of a decoding method according to an embodiment of this application. As shown in FIG. 10, the method may include the following steps 101 to 104.

In step 101, a candidate data processing mode is determined based on a first preset condition.

It should be noted that the decoding method in embodiments of this application is applied to a decoder (or referred to as “entropy decoder”). In addition, the decoding method may specifically refer to a point cloud decoding method, or a point cloud entropy decoding method. According to this method, a to-be-decoded syntax element may be decoded, and a bit rate can be reduced.

It should be further noted that, in embodiments of this application, a data processing mode may be used to implement a decoding function. In other words, the data processing mode herein may be considered as a decoding method/an entropy decoding method, or may be considered as a decoder/an entropy decoder.

It should be understood that, in embodiments of this application, there may be a plurality of candidate data processing modes, that is, there are a plurality of candidate decoders. Subsequently, a target decoder is selected from the plurality of candidate decoders, to decode a to-be-decoded syntax element by using the selected target decoder. In addition, in embodiments of this application, there may be only one candidate data processing mode, that is, there is only one candidate decoder. In this case, different configuration parameters may be set for the candidate decoder, and then a to-be-decoded syntax element is decoded by using a decoder corresponding to a target configuration parameter, which is not limited herein.

It should be further understood that, in embodiments of this application, the first preset condition may be related to a threshold parameter (for example, an upper probability limit and/or a lower probability limit). The candidate data processing mode is determined based on the first preset condition, so that decoding efficiency can be improved in a decoding process.

In some embodiments, the process of determining the candidate data processing mode based on the first preset condition may include: determining a threshold parameter of the candidate data processing mode based on the first preset condition.

It should be noted that, in embodiments of this application, the threshold parameter may indicate a probability threshold of the candidate data processing mode, and the probability threshold includes an upper probability limit and/or a lower probability limit. In other words, in embodiments of this application, the probability threshold of the candidate data processing mode may be set, so that probability thresholds of the candidate data processing mode are arranged in descending order or ascending order.

Further, in some embodiments, a sorting indication parameter may be determined based on the threshold parameter of the candidate data processing mode.

It should be further noted that, in embodiments of this application, values of the sorting indication parameter include a first preset value and a second preset value. The first preset value indicates descending order of threshold parameters, and the second preset value indicates ascending order of threshold parameters.

For example, assuming that there are K candidate data processing modes, and lower probability limits of the K candidate data processing modes are L₀, L₁≤ . . . ≤Lᵢ . . . L_{K-1} in sequence; for the first preset value, descending order of the lower probability limits is L₀≥L₁≥ . . . ≥Lᵢ≥ . . . ≥L_{K-1}, and for the second preset value, ascending order of the lower probability limits is L₀≤L₁≤ . . . ≤Lᵢ≤ . . . ≤L_{K-1}. Upper probability limits of the K candidate data processing modes are U₀, U₁ . . . Uᵢ . . . U_{K-1} in sequence; for the first preset value, descending order of the upper probability limits is U₀≥U₁ . . . Uᵢ . . . U_{K-1}, and for the second preset value, ascending order of the upper probability limits is U₀≤U₁≤ . . . ≤Uᵢ≤ . . . ≤U_{K-1}.

In some embodiments, i=1, 2, . . . , K−1, where K denotes a quantity of candidate data processing modes.

In a possible implementation, when the value of the sorting indication parameter is determined, a third preset value and a fourth preset value of the candidate data processing mode may be further determined; and the value of the sorting indication parameter may be determined based on the third preset value and the fourth preset value.

It should be understood that, in embodiments of this application, the third preset value indicates probability value update order of the candidate data processing mode, and the fourth preset value indicates index value update order of the candidate data processing mode.

In other words, the third preset value may indicate an update direction of probabilities of a candidate decoder, and the fourth preset value may indicate an update direction of an index mapping table of the candidate decoder. In this way, whether threshold parameters (such as the lower probability limit or the upper probability limit) are arranged in descending order or ascending order can be determined based on the update direction of the probabilities of the candidate decoder and the update direction of the index mapping table of the candidate decoder.

It should be further understood that, in embodiments of this application, in a possible implementation, if the third preset value is equal to 1, it indicates that the update direction of the probabilities of the candidate decoder is a descending direction; or if the third preset value is equal to 0, it indicates that the update direction of the probabilities of the candidate decoder is an ascending direction. If the fourth preset value is equal to 1, it indicates that the update direction of the index mapping table of the candidate decoder is a descending direction; or if the fourth preset value is equal to 0, it indicates that the update direction of the index mapping table of the candidate decoder is an ascending direction.

In another possible implementation, if the third preset value is equal to 0, it indicates that the update direction of the probabilities of the candidate decoder is a descending direction; or if the third preset value is equal to 1, it indicates that the update direction of the probabilities of the candidate decoder is an ascending direction. If the fourth preset value is equal to 0, it indicates that the update direction of the index mapping table of the candidate decoder is a descending direction; or if the fourth preset value is equal to 1, it indicates that the update direction of the index mapping table of the candidate decoder is an ascending direction.

In a specific embodiment, when the value of the sorting indication parameter is determined based on the third preset value and the fourth preset value, if the third preset value is different from the fourth preset value, it is determined that the value of the sorting indication parameter is the first preset value; or if the third preset value is the same as the fourth preset value, it is determined that the value of the sorting indication parameter is the second preset value.

It should be further noted that, in embodiments of this application, if the third preset value is different from the fourth preset value, it indicates that the update direction of the probabilities of the candidate decoder is opposite to the update direction of the index mapping table of the candidate decoder, and in this case, the value of the sorting indication parameter is the first preset value, that is, the sorting indication parameter indicates that the threshold parameters are arranged in descending order, L₀≥L₁≥ . . . ≥Lᵢ≥ . . . ≥L_{K-1}, and U₀≥U₁≥ . . . ≥Uᵢ≥ . . . ≥U_{K-1}. If the third preset value is the same as the fourth preset value, it indicates that the update direction of the probabilities of the candidate decoder is the same as the update direction of the index mapping table of the candidate decoder, and in this case, the value of the sorting indication parameter is the second preset value, that is, the sorting indication parameter indicates that the threshold parameters are arranged in ascending order, L₀≤L₁ . . . ≤Lᵢ≤ . . . ≤L_{K-1}, and U₀≤U₁≤ . . . ≤Uᵢ≤ . . . ≤U_{K-1}.

It should be further understood that, in embodiments of this application, if probability values of the candidate decoder increase (or remain unchanged) or decrease (remain unchanged) with corresponding index value in the index mapping table, it may be determined that the update direction of the probabilities of the candidate decoder is the same as the update direction of the index mapping table of the candidate decoder; otherwise, it may be determined that the update direction of the probabilities of the candidate decoder is opposite to the update direction of the index mapping table of the candidate decoder.

In another possible implementation, when the value of the sorting indication parameter is determined, a first parameter corresponding to the candidate data processing mode may be further determined; and the value of the sorting indication parameter may be determined based on the first parameter.

It should be understood that, in embodiments of this application, the first parameter corresponding to the candidate data processing mode may refer to a symbol corresponding to a probability value stored in the candidate decoder. For example, the first parameter may indicate a specific value such as 0 or 1; or the first parameter may indicate a symbol in binary arithmetic decoding, for example, a symbol of 0 or 1, which is not limited herein.

In a specific embodiment, when the value of the sorting indication parameter is determined based on the first parameter, if the first parameter indicates first data, it is determined that the value of the sorting indication parameter is the first preset value; or if the first parameter indicates second data, it is determined that the value of the sorting indication parameter is the second preset value.

It should be further understood that, in embodiments of this application, the first data may be a symbol “0”, and the second data may be a symbol “1”. For example, if the probability value stored in the candidate decoder is a probability value of the symbol “0” with 16-bit precision, the value of the sorting indication parameter is the first preset value, that is, the sorting indication parameter may indicate that lower probability limits are arranged in descending order, L₀≥L₁≥ . . . ≥Lᵢ≥ . . . ≥L_{K-1}; and may indicate upper probability limits are arranged in descending order, U₀≥U₁≥ . . . ≥Uᵢ≥ . . . ≥U_{K-1}. If the probability value stored in the candidate decoder is a probability value of the symbol “1” with 16-bit precision, the value of the sorting indication parameter is the second preset value, that is, the sorting indication parameter may indicate that lower probability limits are arranged in ascending order, L₀≤L₁≤ . . . ≤Lᵢ≤ . . . ≤L_{K-1}; and may indicate upper probability limits are arranged in ascending order, U₀≤U₁≤ . . . ≤Uᵢ≤ . . . ≤U_{K-1}.

In this way, whether the threshold parameters are arranged in descending order or ascending order can be determined based on the update direction of the probabilities of the candidate decoder and the update direction of the index mapping table of the candidate decoder, or based on the symbol (Symbol) corresponding to the probability value stored in the candidate decoder. In addition, the threshold parameters herein may include a lower probability limit and/or an upper probability limit.

In still another possible implementation, the method may further include: when the value of the sorting indication parameter is the first preset value, in a case that the threshold parameter is the lower probability limit, it is determined that Lᵢ₋₁ is greater than or equal to Lᵢ; or in a case that the threshold parameter is the upper probability limit, it is determined that Uᵢ₋₁ is greater than or equal to Uᵢ; and

when the value of the sorting indication parameter is the second preset value, in a case that the threshold parameter is the lower probability limit, it is determined that Lᵢ₋₁ is less than or equal to Lᵢ; or in a case that the threshold parameter is the upper probability limit, it is determined that Uᵢ₋₁ is less than or equal to Uᵢ.

In embodiments of this application, Lᵢ denotes the lower probability limit of the candidate data processing mode, Uᵢ denotes the upper probability limit of the candidate data processing mode, and i=1, 2, . . . , K−1, where K denotes a quantity of candidate data processing modes.

For example, when the value of the sorting indication parameter is the first preset value, L₀≥L₁≥ . . . ≥Lᵢ≥L_{K-1}, and U₀≥U₁≥ . . . ≥Uᵢ≥ . . . ≥U_{K-1}; or when the value of the sorting indication parameter is the second preset value, L₀≤L₁≤ . . . ≤Lᵢ≤ . . . ≤L_{K-1}, and U₀≤U₁≤ . . . ≤Uᵢ≤ . . . ≤U_{K-1}.

In still another possible implementation, the method may further include: in the candidate data processing mode, determining that a lower probability limit of a current candidate data processing mode is the same as an upper probability limit of an adjacent candidate data processing mode, and determining that an upper probability limit of the current candidate data processing mode is the same as a lower probability limit of the adjacent candidate data processing mode.

In a specific embodiment, if the third preset value is different from the fourth preset value, it is determined that Lᵢ₋₁=Uᵢ; or if the third preset value is the same as the fourth preset value, it is determined that Uᵢ₋₁=Lᵢ.

In embodiments of this application, the upper probability limit and the lower probability limit in the candidate decoder are required to meet: a lower probability limit of a current candidate decoder is the same as an upper probability limit of an adjacent candidate decoder, and an upper probability limit of the current candidate decoder is the same as a lower probability limit of the adjacent candidate decoder.

For example, if the update direction of the probabilities of the candidate decoder is opposite to the update direction of the index mapping table of the candidate decoder, Lᵢ₋₁ and Uᵢ are required to meet: Lᵢ₋₁=Uᵢ; or if the update direction of the probabilities of the candidate decoder is the same as the update direction of the index mapping table of the candidate decoder, Lᵢ₋₁ and Uᵢ are required to meet: Uᵢ₋₁=Lᵢ.

In other words, in embodiments of this application, high and low thresholds (that is, the upper probability limit and the lower probability limit) may be set for probability value update of different candidate data processing modes (one or more decoders).

For example, in this application, for K decoders used, an index value i thereof ranges from 0 to K−1. For each decoder, dual thresholds of probability update are set, including a low threshold Lᵢ and a high threshold Uᵢ, which are required to meet Lᵢ≤Uᵢ. An i^{th} decoder is used as an example. A probability value Pᵢ of the i^{th} decoder is constrained within an interval between the dual thresholds, and Pᵢ=Clip3(Lᵢ, Uᵢ, Pᵢ), where Clip3(x, y, z) is a clipping calculation function as follows:

$$Clip 3 ( x , y , z ) = \{ \begin{matrix}x ; & z < x \\ y ; & z > y \\ z ; & otherwise\end{matrix} \qquad ( 11 )$$

In which, i=0, 1, 2, . . . , K−1, where K denotes a quantity of candidate data processing modes.

During decoding of a binary symbol (to-be-decoded syntax element), when both a probability value Pᵢ of the decoder and a corresponding index i in the mapping table increase (or remain unchanged), it is determined that an update direction of probabilities of the decoder is the same as an update direction of the index mapping table; otherwise, it is determined that the update direction of probabilities of the decoder is opposite the update direction of the index mapping table.

If the update direction of the probabilities of the decoder is opposite to the update direction of the index mapping table, the following is required to be met: L₀≥L₁≥ . . . ≥Lᵢ≥ . . . ≥L_{K-2}≥L_{K-1}, U₀≤U₁≤ . . . ≤Uᵢ≤ . . . ≤U_{K-2}≤U_{K-1}, Lᵢ=Uᵢ₊₁ (0≤i≤K−2), Uᵢ=Lᵢ₋₁ (1≤i≤K).

If the update direction of the probabilities of the decoder is the same as the update direction of the index mapping table, the following is required to be met: L₀≤L₁≤ . . . ≤Lᵢ≤ . . . ≤L_{K-2}≤L_{K-1}, U₀≤U₁ . . . ≤Uᵢ≤ . . . U_{K-2}≤U_{K-1}, Uᵢ=Lᵢ₊₁ (0≤i≤K−2), Lᵢ=Uᵢ₋₁ (1≤i≤K).

For example, assuming that a probability value stored in the decoder is a probability value of the symbol “0” with 16-bit precision, and a value of K is 32, the update direction of probabilities of the decoder is opposite to the update direction of the index mapping table. Therefore, a low threshold Lᵢ and a high threshold Uᵢ meet: L₀≥L₁≥ . . . ≥Lᵢ≥ . . . ≥L_{K-2}>L_{K-1} and U₀≥U₁≥ . . . ≥Uᵢ≥ . . . ≥U_{K-2}≥U_{K-1}. At the endpoints, Lᵢ=Uᵢ₊ᵢ(0≤i≤K−2), and Uᵢ=Lᵢ₋₁ (1≤i≤K). Initial values Lᵢ⁰, Uᵢ⁰ of a low threshold and a high threshold of K=32 decoders may be set as shown in Table 3.

TABLE 3
obufSingleBoundOrigin [32][2] (index 0 to 31)

{{65535, 65388}, {65388, 64933}, {64933, 64169}, {64169, 63105}, {63105,
61747}, {61747, 60112}, {60112, 58214}, {58214, 56069}, {56069, 53699},
{53699, 51128}, {51128, 48379}, {48379, 45480}, {45480, 42458}, {42458,
39340}, {39340, 36160}, {36160, 32946}, {32946, 29730}, {29730, 26541},
{26541, 23413}, {23413, 20374}, {20374, 17454}, {17454, 14681}, {14681,
12083}, {12083, 9684}, {9684, 7509}, {7509, 5575}, {5575, 3905}, {3905, 2515},
{2515, 1419}, {1419, 627}, {627, 150}, {150, 0}}

For a specific process of setting the low threshold Lᵢ and the high threshold Uᵢ, reference may be made to Table 4.

TABLE 4

for i=0 to K−1
Lᵢ = obufSingleBoundOrigin[i][1]
Uᵢ = obufSingleBoundOrigin[i][0]

That is, according to the foregoing Table 3, the low threshold Lᵢ is set to a second value in an i^{th} two-dimensional array, and the high threshold Uᵢ is set to a first value in the i^{th} two-dimensional array.

In step 102, a data processing mode parameter corresponding to a to-be-decoded syntax element is determined.

In step 103, a target data processing mode is determined based on the candidate data processing mode and the data processing mode parameter.

It should be noted that, in embodiments of this application, the to-be-decoded syntax element specifically refers to a syntax element to be decoded on a decoding side. The syntax element herein may be a symbol in binary arithmetic decoding, or may be any syntax element written into a bitstream, which is not limited herein.

It should be further noted that, in embodiments of this application, the data processing mode parameter specifically refers to an index value corresponding to the candidate data processing mode. In some embodiments, the process of determining the data processing mode parameter corresponding to the to-be-decoded syntax element may include: determining context information of the to-be-decoded syntax element; and determining the data processing mode parameter based on the context information and a preset mapping table.

It may be understood that, in embodiments of this application, the preset mapping table may be a mapping relationship look up table. On the decoding side, the preset mapping table may be a candidate decoder index mapping table.

Further, in some embodiments, the process of determining the data processing mode parameter based on the context information and the preset mapping table may include: determining a context state of the to-be-decoded syntax element based on the context information; and determining the data processing mode parameter based on the context state and the preset mapping table.

It should be noted that, in embodiments of this application, the preset mapping table may be used to represent a mapping relationship between the context state and the data processing mode parameter. For example, based on the preset mapping table, an index value of a decoder corresponding to any context state (context information) may be determined.

It should be further noted that, in embodiments of this application, the context information may be classified into primary information and secondary information depending on importance of the information. The primary information is not reduced, while the secondary information may be reduced. After a dynamic reduction process, context information that is retained forms a context state (denoted by D). For each context state D, a counter N is provided to record a quantity of times a current state D has been accessed. If N is greater than a preset threshold, the dynamic reduction process is updated, that is, for a syntax element to be decoded subsequently, more secondary information forms a new context state D.

In this way, after the context state D is determined, the data processing mode parameter corresponding to the to-be-decoded syntax element may be determined according to the preset mapping table. The preset mapping table records a mapping relationship between multiple pairs of context states and data processing mode parameters, and there is also a correspondence between the data processing mode parameter and a data processing mode, so that the target data processing mode (namely, a target decoder) corresponding to the to-be-decoded syntax element can be determined.

Further, in some embodiments, the method may further include: updating the preset mapping table based on a value of the to-be-decoded syntax element.

In a specific embodiment, the process of updating the preset mapping table may include:
reducing data processing mode parameters in the preset mapping table in a case that the value of the to-be-decoded syntax element is a fifth preset value; or
increasing data processing mode parameters in the preset mapping table in a case that the value of the to-be-decoded syntax element is a sixth preset value.

It should be noted that, in embodiments of this application, the fifth preset value is different from the sixth preset value, and the fifth preset value and the sixth preset value may be in a parameter form, or may be in a digital form. Specifically, the to-be-decoded syntax element may be a parameter written in a profile, or may be a value of a flag, which is not specifically limited herein.

For example, the fifth preset value may be set to 1, and the sixth preset value may be set to 0. Alternatively, the fifth preset value may be set to 0, and the sixth preset value may be set to 1. Alternatively, the fifth preset value may be set to true, and the sixth preset value may be set to false. Alternatively, the fifth preset value may be set to false, and the sixth preset value may be set to true. In embodiments of this application, the fifth preset value is 0, and the sixth preset value is 1, which is not specifically limited.

It should be further noted that, in embodiments of this application, after one syntax element is decoded each time, the data processing mode parameter in the preset mapping table may be adjusted based on a value of the syntax element. For example, if a value of a syntax element currently to be decoded is 0, the data processing mode parameter may be reduced (or remain unchanged); or if a value of a syntax element currently to be decoded is 1, the data processing mode parameter may be increased (or remain unchanged), so as to update the preset mapping table.

In some embodiments, the decoder index mapping table (that is, the preset mapping table) provides a mapping relationship between a context state and a decoder index value. Based on the mapping table, a decoder index value that should be used by a to-be-decoded syntax element in any context state may be obtained. After one syntax element is decoded each time, the mapping relationship between the context state D and the decoder index value in the mapping table is adjusted based on a decoding result of the syntax element.

For example, the decoder index mapping table may store an 8-bit decoder index value. When a symbol currently to be decoded is “1”, the decoder index value is increased (or remains unchanged). When a symbol currently to be decoded is “0”, the decoder index value is reduced (or remains unchanged).

A specific update manner is as follows: stateVal denotes the decoder index value, CtxMap denotes the decoder index mapping table, ctxMapIdx denotes the context state D, and binVal denotes the symbol currently to be decoded. Herein, ctxMapTransition represents a query table, as shown in Table 1, which shows values of ctxMapTransition[i].

For example, a specific update process is described as follows:

```
stateVal = CtxMap[ctxMapIdx]
if (binVal)
  CtxMap[ctxMapIdx] += ctxMapTransition[(255−stateVal)>>4];
else
  CtxMap[ctxMapIdx] −= ctxMapTransition[stateVal>>4]
```

After stateVal is obtained, a decoder corresponding to the symbol (syntax element) currently to be decoded may be obtained. A decoder index value may be in a one-to-one correspondence with a decoder, or further mapping may be performed on the decoder index value, that is, a plurality of decoder index values may correspond to one decoder, so as to obtain a final decoder index value.

For example, a secondary mapping process may be added, that is, a binary decoder index value obtained is used as an intermediate value (an intermediate index value), and an actual index value may be further determined. For example, stateVal is required to be right shifted by two bits to obtain a final decoder index value.

In step 104, the to-be-decoded syntax element is decoded based on the target data processing mode, to determine a value of the to-be-decoded syntax element.

It should be noted that, in embodiments of this application, after the target data processing mode (namely, the target decoder) is determined, the to-be-decoded syntax element may be decoded based on the target data processing mode, to obtain the value of the to-be-decoded syntax element.

It should be further noted that, in embodiments of this application, after the to-be-decoded syntax element is decoded, a probability value corresponding to the target decoder is further required to be determined and updated. Therefore, in some embodiments, the method may further include: determining a first probability value of the target data processing mode based on the value of the to-be-decoded syntax element; and updating the first probability value of the target data processing mode to determine a second probability value of the target data processing mode.

It should be noted that, in embodiments of this application, after the second probability value of the target data processing mode is obtained by updating, the second probability value of the target data processing mode may be modified, to determine a target probability value of the target data processing mode.

In some embodiments, the process of updating the first probability value of the target data processing mode to determine the second probability value of the target data processing mode may include: determining a second parameter corresponding to the target data processing mode; and updating the first probability value of the target data processing mode based on the second parameter and the value of the to-be-decoded syntax element, to determine the second probability value of the target data processing mode.

It should be understood that, in embodiments of this application, the second parameter corresponding to the target data processing mode may refer to a symbol corresponding to a probability value stored in the target decoder. For example, the second parameter may indicate a specific value such as 0 or 1; or the second parameter may indicate a symbol in binary arithmetic decoding, for example, a symbol of 0 or 1, which is not limited herein.

It should be further understood that, in embodiments of this application, after the to-be-decoded syntax element is decoded, if the probability value of the target decoder represents a probability of the second parameter, the probability value of the target decoder may be increased or reduced depending on data indicated by the second parameter.

In a possible implementation, the process of updating the first probability value of the target data processing mode based on the second parameter and the value of the to-be-decoded syntax element may include:
in a case that the second parameter indicates first data, and the value of the to-be-decoded syntax element is a fifth preset value, increasing the first probability value of the target data processing mode; or
in a case that the second parameter indicates first data, and the value of the to-be-decoded syntax element is a sixth preset value, reducing the first probability value of the target data processing mode.

Alternatively, in another possible implementation, the process of updating the first probability value of the target data processing mode based on the second parameter and the value of the to-be-decoded syntax element may include:
in a case that the second parameter indicates second data, and a symbol for the to-be-decoded syntax element is a fifth preset value, reducing the first probability value of the target data processing mode; or
in a case that the second parameter indicates second data, and a symbol for the to-be-decoded syntax element is a sixth preset value, increasing the first probability value of the target data processing mode.

For example, if the probability value of the target decoder represents a probability of the symbol “0”, when a syntax element currently to be decoded is 0, the probability value of the target decoder is increased (or remains unchanged); or when a syntax element currently to be decoded is 1, the probability value of the target decoder is reduced (or remains unchanged). If the probability value of the target decoder represents a probability of the symbol “1”, when a syntax element currently to be decoded is 0, the probability value of the target decoder is reduced (or remains unchanged); or when a syntax element currently to be decoded is 0, the probability value of the target decoder is increased (or remains unchanged).

It should be noted that, in embodiments of this application, during updating of the first probability value, the first probability value may be increased based on a preset attenuation factor; or the first probability value may be reduced based on a preset attenuation factor.

For example, in embodiments of this application, assuming that a probability value of a decoder represents a probability of the symbol “0”; after the symbol “0” is decoded, the probability value of the decoder is increased (or remains unchanged), and after the symbol “1” is decoded, the probability value of the decoder is reduced (or remains unchanged). A manner in which the first probability value is updated may be as shown in the formula (9), where a denotes the attenuation factor.

It should be noted that, in embodiments of this application, during updating of the first probability value, the first probability value may be increased according to a first pre-stored look up table; or the first probability value may be reduced according to a first pre-stored look up table.

For example, in embodiments of this application, the first probability value may be updated using a look up table. If the probability is represented with 16-bit precision, the formula (9) may be approximately converted into a formula (10), where diracLut denotes the look up table, as shown in Table 2.

For example, in embodiments of this application, for K decoders used, an index value i thereof ranges from 0 to K−1. In a decoding process, the probability value P₁ of the target decoder is continuously updated with accumulation of binary symbols binVal (a value of the to-be-decoded syntax element) decoded. Assuming that a j^{th} update is being performed currently, a current probability value (the second probability value) is Pᵢ^{j}, and a probability value before the update (the first probability value) is Pᵢ^{j-1}. The algorithm shown in Table 5 may be used in the probability update process. In which, diracLut[ ] is shown in Table 2, that is, an adjustment value (update amplitude) for probability update may be quickly obtained by looking up Table 2.

TABLE 5

Update_probability ( )
Pᵢ^{j} ← Pᵢ^{j-1}
if binVal == 0:
Pᵢ^{j}+= diracLut[255− Pᵢ^{j}>>8 ]
else:
Pᵢ^{j} −= diracLut[ Pᵢ^{j}>>8]
return Pᵢ^{j}

It should be noted that, in embodiments of this application, the update amplitude ΔPᵢ^{j} used in the update process of the first probability value may be a fixed value or a dynamic value, and may be related to or independent of the index value i of the decoder, which is not specifically limited in this application.

Further, in some embodiments, the second probability value of the target data processing mode may be modified by using a threshold parameter of the target data processing mode, to determine the target probability value of the target data processing mode.

In a specific embodiment, the process of modifying the second probability value of the target data processing mode to determine the target probability value of the target data processing mode may include:
in a case that the second probability value is less than a lower probability limit of the target data processing mode, setting the target probability value to the lower probability limit of the target data processing mode;
in a case that the second probability value is greater than an upper probability limit of the target data processing mode, setting the target probability value to the upper probability limit of the target data processing mode; or
in a case that the second probability value is greater than or equal to a lower probability limit and less than or equal to an upper probability limit of the target data processing mode, setting the target probability value to the second probability value.

It should be noted that, in embodiments of this application, the second probability value of the target data processing mode may be denoted by Pᵢ. Thus, for Pᵢ, two thresholds may be set: an upper probability limit (a high threshold) Uᵢ and a lower probability limit (a low threshold) Lᵢ, and the two thresholds should meet Lᵢ≤Uᵢ.

For example, for K decoders used, an index value i thereof ranges from 0 to K−1. In a decoding process, the probability value Pᵢ of the target decoder is continuously updated with accumulation of binary symbols binVal (a value of the to-be-decoded syntax element) decoded. Assuming that a j^{th} update is being performed currently, a current probability value (the second probability value) is Pᵢ^{j}, and a probability value before the update (the first probability value) is Pᵢ^{j-1}. After the update of the probability value is completed, the second probability value P is modified based on a high threshold Uᵢ^{j-1} and a low threshold Lᵢ^{j-1} of a decoder i. For example, Pᵢ^{j}=Clip3(Lᵢ^{j-1}, Uᵢ^{j-1}, Pᵢ^{j}), where Clip3(x, y, z) is a clipping calculation function.

It should be noted that, in embodiments of this application, for a decoder k (k∈[0, K], k≠i) other than the target decoder, a probability value Pₖ^{j} of the decoder k remains unchanged during this update, and Pₖ^{j}=Pₖ^{j-1}.

Further, in embodiments of this application, after the first probability value of the target data processing mode is updated to determine the corresponding second probability value, the threshold parameter of the target data processing mode may be adjusted based on the second probability value, to determine an adjusted threshold parameter.

That is, in embodiments of this application, the threshold parameter of the data processing mode may be dynamically adjusted. For example, high and low probability thresholds (a lower probability limit or an upper probability limit) of a decoder may be dynamically adjusted.

Further, in embodiments of this application, the process of adjusting the threshold parameter of the target data processing mode based on the second probability value, to determine the adjusted threshold parameter includes: if the second probability value is less than the lower probability limit of the target data processing mode, reducing the lower probability limit of the target data processing mode to determine an adjusted lower probability limit; and determining the adjusted threshold parameter based on the adjusted lower probability limit and the upper probability limit of the target data processing mode.

Further, in embodiments of this application, the process of adjusting the threshold parameter of the target data processing mode based on the second probability value, to determine the adjusted threshold parameter includes: if the second probability value is greater than the upper probability limit of the target data processing mode, increasing the upper probability limit of the target data processing mode to determine an adjusted upper probability limit; and determining the adjusted threshold parameter based on the adjusted upper probability limit and the lower probability limit of the target data processing mode.

In other words, in embodiments of this application, the process of adjusting the threshold parameter of the target data processing mode includes: increasing the upper probability limit of the target data processing mode, and forming the adjusted threshold parameter by the lower probability limit before the adjustment and the adjusted upper probability limit; or reducing the lower probability limit of the target data processing mode, and forming the adjusted threshold parameter by the upper probability limit before the adjustment and the adjusted lower probability limit.

Further, in embodiments of this application, the process of adjusting the threshold parameter of the target data processing mode includes: determining adjustment amplitude according to a second pre-stored look up table (such as Table 6), where the adjustment amplitude is used to increase the upper probability limit, or reduce the lower probability limit; and adjusting the threshold parameter of the target data processing mode based on the adjustment amplitude.

It should be noted that, in embodiments of this application, during adjustment of the threshold parameter of the target data processing mode, the selected adjustment amplitude may include ΔUᵢ^{j} for increasing the upper probability limit, or may include ΔLᵢ^{j} for reducing the lower probability limit, where the adjustment amplitudes ΔUᵢ^{j} and ΔLᵢ^{j} may be identical, and may be fixed values or values dynamically changing with the decoder index value i. The value of the adjustment amplitude is not limited in this application.

For example, in embodiments of this application, the process of dynamically adjusting high and low probability thresholds U₁ and Lᵢ of the decoder I includes: adjusting the high and low thresholds of the decoder based on the updated second probability value Pᵢ^{j} of the decoder i, referring to a formula (12):

$${U}_{i}^{j} = \{ \begin{matrix}{U}_{i}^{j - 1} + Δ {U}_{i}^{j} & {P}_{i}^{j} > {U}_{i}^{j - 1} \\ {U}_{i}^{j - 1} & {P}_{i}^{j} \leq {U}_{i}^{j - 1}\end{matrix} \\ {L}_{i}^{j} = \{ \begin{matrix}{L}_{i}^{j - 1} - Δ {L}_{i}^{j} & {P}_{i}^{j} < {L}_{i}^{j - 1} \\ {L}_{i}^{j - 1} & {P}_{i}^{j} \geq {L}_{i}^{j - 1}\end{matrix} \qquad ( 12 )$$

If the updated second probability value of the decoder i is greater than a high threshold Uᵢ^{j-1} of the decoder i before update, the high threshold is increased, for example, ΔUᵢ^{j} is added to the high threshold Uᵢ^{j-1}. If the updated probability value of the decoder i is less than a low threshold Lᵢ^{j-1} of the decoder i before update, the low threshold is reduced, for example, ΔLᵢ^{j} is subtracted from the low threshold Lᵢ^{j-1}. If the updated probability value of the decoder i is within a probability interval [Lᵢ^{j-1}, Uᵢ^{j-1}] of the decoder i before update, the high and low thresholds are not adjusted.

For example, in embodiments of this application, values of adjustment amplitudes U and ΔLᵢ^{j} may be determined jointly based on a probLut jump table containing 256 values shown in Table 6 and first eight bits of a current probability value (with 16-bit precision). That is, values of adjustment amplitudes ΔUᵢ^{j} and ΔLᵢ^{j} may be determined according to the following formula (13):

$$\{ \begin{matrix}Δ {U}_{i}^{j} = probLut [ 255 - {P}_{i}^{j} >> 8 ] \\ Δ {L}_{i}^{j} = probLut [ {P}_{i}^{j} >> 8 ]\end{matrix} \qquad ( 13 )$$

TABLE 6
probLut [256] (index 0 to 255)

0, 0, 1, 2, 2, 3, 5, 6, 7, 8, 10, 11, 13, 15, 16, 18, 20, 22, 24,
26, 28, 30, 33, 35, 37, 40, 42, 45, 47, 50, 52, 55, 58, 61, 64, 66, 69,
72, 75, 78, 81, 85, 88, 91, 94, 98, 101, 104, 108, 111, 115, 118, 122,
126, 129, 133, 137, 140, 144, 148, 152, 156, 160, 164, 168, 172, 176,
180, 184, 188, 192, 197, 201, 205, 210, 214, 218, 223, 227, 232, 236,
241, 245, 250, 255, 259, 264, 269, 273, 278, 283, 288, 293, 298, 302,
307, 312, 317, 322, 327, 333, 338, 343, 348, 353, 358, 364, 369, 374,
380, 385, 390, 396, 401, 407, 412, 417, 423, 429, 434, 440, 445, 451,
457, 462, 468, 474, 480, 483, 485, 487, 488, 490, 492, 493, 495, 496,
497, 499, 500, 501, 502, 504, 505, 506, 507, 508, 509, 510, 511, 511,
512, 513, 514, 514, 515, 515, 516, 516, 517, 517, 517, 517, 518, 518,
518, 518, 518, 518, 517, 517, 517, 517, 516, 516, 515, 515, 514, 513,
513, 512, 511, 510, 509, 508, 507, 506, 504, 503, 502, 500, 499, 497,
495, 493, 492, 490, 488, 485, 483, 481, 479, 476, 474, 471, 468, 465,
462, 459, 456, 453, 450, 446, 443, 439, 435, 431, 427, 423, 419, 414,
410, 405, 400, 395, 390, 385, 379, 373, 367, 361, 355, 349, 342, 335,
328, 320, 312, 304, 296, 287, 278, 269, 259, 248, 238, 226, 214, 201,
187, 172, 156, 138, 117, 94, 63

Further, in embodiments of this application, the adjusted threshold parameter is modified to determine that an adjusted lower probability limit of the target data processing mode is the same as an upper probability limit of an adjacent candidate data processing mode, or determine that an adjusted upper probability limit of the target data processing mode is the same as a lower probability limit of an adjacent candidate data processing mode.

It should be noted that, in embodiments of this application, after the threshold parameter of the target data processing mode is adjusted, if the lower probability limit is reduced, it is required to ensure that the adjusted lower probability limit of the target data processing mode is the same as the upper probability limit of the adjacent candidate data processing mode; or if the upper probability limit is increased, it is required to ensure that the adjusted upper probability limit of the target data processing mode is the same as the lower probability limit of the adjacent candidate data processing mode.

In other words, in embodiments of this application, both an upper probability limit and a lower probability limit for the decoder may be dynamically updated and adjusted, as long as an updated upper probability limit and an updated lower probability limit can still meet: L₀≥L₁≥ . . . ≥Lᵢ≥ . . . ≥L_{K-1} and U₀≥U₁≥ . . . ≥Uᵢ≥ . . . ≥U_{K-1}; or L₀≤L₁≤ . . . ≤Lᵢ≤ . . . ≤L_{K-1} and U₀≤U₁≤ . . . ≤Uᵢ≤ . . . ≤U_{K-1}.

For example, in embodiments of this application, it is required to ensure that probability intervals of decoders do not overlap after the high and low thresholds are adjusted. When the update direction of probabilities of the decoder is opposite to the update direction of the index mapping table, if an adjusted high threshold Uᵢ^{j} is greater than a high threshold Uᵢ₋₁ of an adjacent decoder, the high threshold Uᵢ^{j} is modified to Uᵢ₋₁^{j} (1≤i≤K); or if an adjusted low threshold L is less than a low threshold Lᵢ₊₁^{j} of an adjacent decoder, the low threshold Lᵢ^{j} is modified to Lᵢ₊₁^{j} (0≤i≤K−2), specifically referring to the following formulas (14) and (15):

$$\begin{matrix}\{ \begin{matrix}{U}_{i}^{j} = min ( {U}_{i - 1}^{j} , {U}_{i}^{j - 1} + Δ {U}_{i}^{j} ) & {P}_{i}^{j} > {U}_{i}^{j - 1} \\ {L}_{i}^{j} = max ( {L}_{i + 1}^{j} , {L}_{i}^{j - 1} - Δ {L}_{i}^{j} ) & {P}_{i}^{j} < {L}_{i}^{j - 1}\end{matrix} & ( 14 ) \\ \{ \begin{matrix}{L}_{i + 1}^{j} = {U}_{i}^{j} & {P}_{i}^{j} > {U}_{i}^{j - 1} \\ {U}_{i - 1}^{j} = {L}_{i}^{j} & {P}_{i}^{j} < {L}_{i}^{j - 1}\end{matrix} & ( 15 )\end{matrix}$$

Further, in embodiments of this application, update amplitude used for updating the first probability value of the target data processing mode is greater than the adjustment amplitude used for adjusting the threshold parameter of the target data processing mode.

In other words, in embodiments of this application, amplitude for updating the probability value of the target data processing mode is greater than amplitude for adjusting the threshold parameter of the target data processing mode. That is, the probability value of the target data processing mode is mainly updated, while the threshold parameter of the target data processing mode is slightly adjusted, that is, the adjustment amplitude should not be greater than the update amplitude for the probability value.

For example, in embodiments of this application, adjustment amplitude values ΔUᵢ^{j} and ΔLᵢ^{j} of high and low probability thresholds may be identical, and may be fixed values or values dynamically changing with the decoder index value i. In a j^{th} update process, both ΔUᵢ^{j} and ΔLᵢ^{j} are less than amplitude (update amplitude) for updating the probability value.

For example, in embodiments of this application, assuming that an update direction of probabilities of decoders (0 to K−1) is opposite to an update direction of the index mapping table, for a specific process of dynamically adjusting dual probability thresholds of the decoder i, reference may be made to Table 7.

TABLE 7
Dynamic_Adjustment ( ):

| | |
|---|---|
| for j←o to N : | // N denotes a quantity of times of |
| | probability updates |
| Pᵢ^{j} ←Update_probability | // update a probability value of |
| (Pᵢ^{j-1}) | a decoder i |

if Pᵢ^{j}> Uᵢ^{j-1}:

| | |
|---|---|
| Pᵢ^{j} ←Uᵢ^{j-1} | // modify an updated probability value |
| Uᵢ^{j} += ΔUᵢ^{j} | // dynamically adjust a high threshold of |
| | the decoder i |

if i > 0 && Uᵢ^{j}> Uᵢ₋₁^{j}:
Uᵢ^{j} = Uᵢ₋₁^{j}

| | |
|---|---|
| Lᵢ₊₁^{j} ← Uᵢ^{j} | // adjust a low threshold of a decoder i+1 |

else if Pᵢ^{j} < Lᵢ^{j-1}:

| | |
|---|---|
| Pᵢ^{j} ← Lᵢ^{j-1} | // modify an updated probability value |
| Lᵢ^{j} −= ΔLᵢ^{j} | // dynamically adjust a low threshold |

if i < K−1 && Lᵢ^{j} < Lᵢ₊₁^{j}:
Lᵢ^{j} = Lᵢ₊₁^{j}

| | |
|---|---|
| Uᵢ₋₁^{j} ← Lᵢ^{j} | // adjust a high threshold of a decoder i−1 |

return Pᵢ^{j}, Lᵢ^{j}, Uᵢ^{j}

After the first probability value Pᵢ^{j-1} of the decoder i is updated to the second probability value Pᵢ^{j}, Pᵢ^{j} may be modified.

In a modification process, if Pᵢ^{j} is greater than a corresponding upper probability limit Uᵢ^{j-1}, Pᵢ^{j} is modified to Uᵢ^{j-1}, and a high threshold Uᵢ^{j-1} of the decoder i is dynamically adjusted, for example, the high threshold is increased using amplitude ΔU. If an adjusted upper probability limit Uᵢ^{j} is greater than an upper probability limit Uᵢ₋₁^{j} of an adjacent decoder, a low threshold Lᵢ₊₁^{j} of a decoder i+1 may be further adjusted to U.

In a modification process, if Pᵢ^{j} is less than a corresponding lower probability limit Lᵢ^{j-1}, Pᵢ^{j} is modified to Lᵢ^{j-1}, and a low threshold Lᵢ^{j-1} of the decoder i is dynamically adjusted to Uᵢ^{j}, for example, the low threshold is reduced using amplitude ΔLᵢ^{j}. If an adjusted lower probability limit Lᵢ^{j} is less than a lower probability limit Lᵢ₊₁^{j} of an adjacent decoder, a high threshold Uᵢ₋₁^{j} of a decoder i−1 may be further adjusted to Lᵢ^{j}.

Further, in embodiments of this application, the second probability value of the target data processing mode may be first modified, and the threshold parameter of the target data processing mode may be then adjusted based on the second probability value, to obtain the adjusted threshold parameter. Alternatively, the threshold parameter of the target data processing mode may be first adjusted based on the second probability value, to determine the adjusted threshold parameter, and the second probability value may be then modified based on the adjusted threshold parameter, to determine the target probability value of the target data processing mode.

In other words, in embodiments of this application, the corresponding second probability value may be modified by using the threshold parameter of the target data processing mode before adjustment, or the corresponding second probability value may be modified by using the adjusted threshold parameter of the target data processing mode. The manner of modifying the second probability is not limited in this application.

For example, in embodiments of this application, after the value of the to-be-decoded syntax element is determined, the first probability value of the target data processing mode may be first determined based on the value of the to-be-decoded syntax element. Then, the first probability value of the target data processing mode is updated, to determine the second probability value of the target data processing mode. Next, the threshold parameter of the target data processing mode may be adjusted based on the second probability value, to determine the adjusted threshold parameter. Finally, the second probability value may be modified based on the adjusted threshold parameter, to determine the target probability value of the target data processing mode.

As described above, according to the decoding method described in steps 101 to 104, a corresponding upper probability limit and a corresponding lower probability limit may be set for each of different candidate decoders based on the first preset condition, where the upper probability limit and the lower probability limit may be dynamically adjusted in a decoding process. In addition, a probability value of a decoder may also be dynamically adjusted, and during adjustment, the probability value may be constrained and modified by using a corresponding upper probability limit and a corresponding lower probability limit.

For example, FIG. 11 is a schematic diagram 1 of implementation of a dynamic adjustment scheme according to this application. As shown in FIG. 11, an initial probability value Pᵢ⁰ and corresponding high and low thresholds Uᵢ⁰ and Lᵢ⁰ of a candidate decoder (candidate data processing mode) may be first initialized based on a first preset condition. After a decoder index (data processing mode parameter) corresponding to a to-be-decoded syntax element is determined based on a context state, a value (binVal) of the to-be-decoded syntax element may be determined based on a target decoder (target data processing mode) indicated by the decoder index. Then, a probability value of the corresponding target decoder may be updated based on the value of the to-be-decoded syntax element, to obtain a second probability value. Subsequently, both the second probability value and the high and low thresholds may be dynamically adjusted.

It may be understood that, in embodiments of this application, the initial probability value of the candidate decoder (candidate data processing mode) may also be set based on the first preset condition. The initial probability value of the candidate decoder that is determined based on the first preset condition may be any value within a range between the corresponding upper probability limit and the corresponding lower probability limit.

Further, in embodiments of this application, in the dynamic adjustment portion in FIG. 11, the process of dynamically adjusting the second probability value and the high and low thresholds may include the following two manners. In a first manner, corresponding threshold parameters (the high and low thresholds) may be first adjusted based on a second probability value obtained by updating, to determine adjusted threshold parameters, and the second probability value may be then modified based on the adjusted threshold parameters, to obtain a modified target probability value. In a second manner, a second probability value obtained by updating may be first modified based on the threshold parameters, to obtain a modified target probability value, and the corresponding threshold parameters may be then adjusted based on the second probability value, to determine adjusted threshold parameters.

It should be noted that, compared with a related technology, octree geometry encoding bitstream performance under lossless conditions achieved by using the decoding method provided in embodiments of this application is as shown in Table 8.

TABLE 8

| Sequence | bpip ratio [%] |
|---|---|
| basketball_player_vox11_00000200 | 98.5% |
| dancer_vox11_00000001 | 98.5% |
| facade_00064_vox11 | 98.5% |
| longdress_vox10_1300 | 98.6% |
| loot_vox10_1200 | 98.5% |
| queen_0200 | 98.6% |
| redandblack_vox10_1550 | 98.7% |
| soldier_vox10_0690 | 98.5% |
| thaidancer_viewdep_vox12 | 98.6% |
| average | 98.6% |

It may be learned that, the decoding method provided in embodiments of this application achieves an average gain of about 1.4% on the geometric bitstream of these data, thereby reducing coding bits.

This embodiment provides a decoding method. In which, a candidate data processing mode is determined by an encoder based on a first preset condition; a data processing mode parameter corresponding to a to-be-encoded syntax element is determined; a target data processing mode is determined based on the candidate data processing mode and the data processing mode parameter; and a value of the to-be-encoded syntax element is encoded based on the target data processing mode to obtain encoded bits, and the encoded bits are written into a bitstream. It may be learned that in embodiments of this application, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

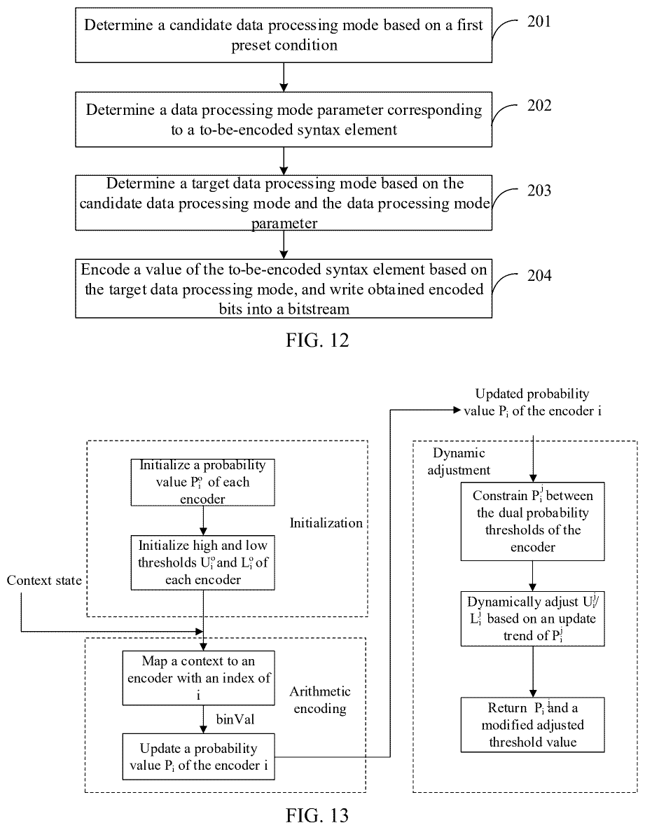

FIG. 12 is a schematic flowchart of an encoding method according to another embodiment of this application. As shown in FIG. 12, the method may include the following steps 201 to 204.

In step 201, a candidate data processing mode is determined based on a first preset condition.

It should be noted that the encoding method in embodiments of this application is applied to an encoder (or referred to as “entropy encoder”). In addition, the encoding method may specifically refer to a point cloud encoding method, or a point cloud entropy encoding method. According to this method, a to-be-encoded syntax element may be encoded, thereby reducing a bit rate.

It should be further noted that, in embodiments of this application, a data processing mode may be used to implement an encoding function. In other words, the data processing mode herein may be considered as an encoding method/an entropy encoding method, or may be considered as an encoder/an entropy encoder.

It should be understood that, in embodiments of this application, there may be a plurality of candidate data processing modes, that is, there are a plurality of candidate encoders. Subsequently, a target encoder is selected from the plurality of candidate encoders, to encode a value of a to-be-encoded syntax element by using the selected target encoder. In addition, in embodiments of this application, there may be only one candidate data processing mode, that is, there is only one candidate encoder. In this case, different configuration parameters of the candidate encoder may be set, and then the value of the to-be-encoded syntax element is encoded by using an encoder corresponding to a target configuration parameter, which is not limited herein.

It should be further understood that, in embodiments of this application, the first preset condition may be related to a threshold parameter (for example, an upper probability limit and/or a lower probability limit). The candidate data processing mode is determined based on the first preset condition, so that encoding efficiency can be improved in an encoding process.

In some embodiments, the process of determining the candidate data processing mode based on the first preset condition may include: determining a threshold parameter of the candidate data processing mode based on the first preset condition.

It should be noted that, in embodiments of this application, the threshold parameter may indicate a probability threshold of the candidate data processing mode, and the probability threshold includes an upper probability limit and/or a lower probability limit. In other words, in embodiments of this application, the probability threshold of the candidate data processing mode may be set, so that probability thresholds of the candidate data processing mode are arranged in descending order or ascending order.

Further, in some embodiments, a sorting indication parameter may be determined based on the threshold parameter of the candidate data processing mode.

It should be further noted that, in embodiments of this application, values of the sorting indication parameter include a first preset value and a second preset value. The first preset value indicates descending order of threshold parameters, and the second preset value indicates ascending order of threshold parameters.

For example, assuming that there are K candidate data processing modes, and lower probability limits of the K candidate data processing modes are L₀, L₁ . . . Lᵢ . . . L_{K-1} in sequence. For the first preset value, descending order of the lower probability limits is L₀≥L₁≥ . . . ≥Lᵢ≥ . . . ≥L_{K-1}, and for the second preset value, ascending order of the lower probability limits is L₀≤L₁≤ . . . ≤Lᵢ≤ . . . ≤L_{K-1}. Upper probability limits of the K candidate data processing modes are U₀, U₁ . . . Uᵢ . . . U_{K-1} in sequence. For the first preset value, descending order of the upper probability limits is U₀, U₁ . . . Uᵢ . . . U_{K-1}, and for the second preset value, ascending order of the upper probability limits is U₀≤U₁≤ . . . ≤Uᵢ≤ . . . ≤U_{K-1}.

In some embodiments, i=1, 2, . . . , K−1, where K denotes a quantity of candidate data processing modes.

In a possible implementation, the process of determining the value of the sorting indication parameter may include: determining a third preset value and a fourth preset value of the candidate data processing mode; and determining the value of the sorting indication parameter based on the third preset value and the fourth preset value.

It should be understood that, in embodiments of this application, the third preset value indicates probability value update order of the candidate data processing mode, and the fourth preset value indicates index value update order of the candidate data processing mode.

In other words, the third preset value may indicate an update direction of probabilities of a candidate encoder, and the fourth preset value may indicate an update direction of an index mapping table of the candidate encoder. In this way, whether threshold parameters (such as the lower probability limit or the upper probability limit) are arranged in descending order or ascending order can be determined based on the update direction of the probabilities of the candidate encoder and the update direction of the index mapping table of the candidate encoder.

It should be further understood that, in embodiments of this application, in a possible implementation, if the third preset value is equal to 1, it indicates that the update direction of the probabilities of the candidate encoder is a descending direction; or if the third preset value is equal to 0, it indicates that the update direction of the probabilities of the candidate encoder is an ascending direction. If the fourth preset value is equal to 1, it indicates that the update direction of the index mapping table of the candidate encoder is a descending direction; and if the third preset value is equal to 0, it indicates that the update direction of the index mapping table of the candidate encoder is an ascending direction.

In another possible implementation, if the third preset value is equal to 0, it indicates that the update direction of the probabilities of the candidate encoder is a descending direction; or if the third preset value is equal to 1, it indicates that the update direction of the probabilities of the candidate encoder is an ascending direction. If the fourth preset value is equal to 0, it indicates that the update direction of the index mapping table of the candidate encoder is a descending direction; and if the third preset value is equal to 1, it indicates that the update direction of the index mapping table of the candidate encoder is an ascending direction.

In a specific embodiment, the process of determining the value of the sorting indication parameter based on the third preset value and the fourth preset value may include: if the third preset value is different from the fourth preset value, determining that the value of the sorting indication parameter is the first preset value; or if the third preset value is the same as the fourth preset value, determining that the value of the sorting indication parameter is the second preset value.

It should be further noted that, in embodiments of this application, if the third preset value is different from the fourth preset value, it indicates that the update direction of the probabilities of the candidate encoder is opposite to the update direction of the index mapping table of the candidate encoder; and in this case, the value of the sorting indication parameter is the first preset value, that is, the sorting indication parameter indicates that the threshold parameters are arranged in descending order, L₀≥L₁≥ . . . ≥Lᵢ≥ . . . ≥L_{K-1}, and U₀≥U₁≥ . . . ≥Uᵢ≥ . . . ≥U_{K-1}. If the third preset value is the same as the fourth preset value, it indicates that the update direction of the probabilities of the candidate encoder is the same as the update direction of the index mapping table of the candidate encoder; and in this case, the value of the sorting indication parameter is the second preset value, that is, the sorting indication parameter indicates the threshold parameters are arranged in ascending order, L₀≤L₁≤ . . . ≤Lᵢ≤ . . . ≤L_{K-1}, and U₀≤U₁≤ . . . ≤Uᵢ≤ . . . ≤U_{K-1}.

It should be further understood that, in embodiments of this application, if probability values of the candidate encoder increase (or remain unchanged) or decrease (remain unchanged) with corresponding index values in the index mapping table, it may be determined that the update direction of the probabilities of the candidate encoder is the same as the update direction of the index mapping table of the candidate encoder; otherwise, it may be determined that the update direction of the probabilities of the candidate encoder is opposite to the update direction of the index mapping table of the candidate encoder.

In another possible implementation, the process of determining the value of the sorting indication parameter may include: determining a first parameter corresponding to the candidate data processing mode; and determining the value of the sorting indication parameter based on the first parameter.

It should be understood that, in embodiments of this application, the first parameter corresponding to the candidate data processing mode may refer to a symbol corresponding to a probability value stored in the candidate encoder. For example, the first parameter may indicate a specific value such as 0 or 1; or the first parameter may indicate a symbol in binary arithmetic encoding, for example, a symbol of 0 or 1, which is not limited herein.

In a specific embodiment, the process of determining the value of the sorting indication parameter may include: if the first parameter indicates first data, determining that the value of the sorting indication parameter is the first preset value; or if the first parameter indicates second data, determining that the value of the sorting indication parameter is the second preset value.

It should be further understood that, in embodiments of this application, the first data may be a symbol “0”, and the second data may be a symbol “1”. For example, if the probability value stored in the candidate encoder is a probability value of the symbol “0” with 16-bit precision, the value of the sorting indication parameter is the first preset value, that is, the sorting indication parameter may indicate that lower probability limits are arranged in descending order, L₀≥L₁≥ . . . ≥Lᵢ≥ . . . ≥L_{K-1}, and may indicate that upper probability limits are arranged in descending order, U₀≥U₁≥ . . . ≥Uᵢ≥ . . . ≥U_{K-1}. If the probability value stored in the candidate encoder is a probability value of the symbol “1” with 16-bit precision, the value of the sorting indication parameter is the second preset value, that is, the sorting indication parameter may indicate that lower probability limits are arranged in ascending order, L₀≤L₁≤ . . . ≤Lᵢ≤ . . . ≤L_{K-1}, and may indicate that upper probability limits are arranged in ascending order, U₀≤U₁≤ . . . ≤Uᵢ≤ . . . ≤U_{K-1}.

In this way, whether the threshold parameters are arranged in descending order or ascending order can be determined based on the update direction of the probabilities of the candidate encoder and the update direction of the index mapping table of the candidate encoder, or based on the symbol corresponding to the probability value stored in the candidate encoder. In addition, the threshold parameters herein may include a lower probability limit and/or an upper probability limit.

In still another possible implementation, the method may further include: when the value of the sorting indication parameter is the first preset value, in a case that the threshold parameter is the lower probability limit, determining that Lᵢ₋₁ is greater than or equal to Lᵢ; or in a case that the threshold parameter is the upper probability limit, determining that Uᵢ₋₁ is greater than or equal to Uᵢ; and
when the value of the sorting indication parameter is the second preset value, in a case that the threshold parameter is the lower probability limit, determining that Lᵢ₋₁ is less than or equal to Lᵢ; or in a case that the threshold parameter is the upper probability limit, determining that Uᵢ₋₁ is less than or equal to Uᵢ.

In embodiments of this application, Lᵢ denotes the lower probability limit of the candidate data processing mode, Uᵢ denotes the upper probability limit of the candidate data processing mode, and i=1, 2, . . . , K−1, where K denotes a quantity of candidate data processing modes.

For example, when the value of the sorting indication parameter is the first preset value, L₀≥L₁≥ . . . ≥Lᵢ≥ . . . ≥L_{K-1}, and U₀≥U₁≥ . . . ≥Uᵢ≥ . . . ≥U_{K-1}; or when the value of the sorting indication parameter is the second preset value, L₀≤L₁≤ . . . ≤Lᵢ≤ . . . ≤L_{K-1}, and U₀≤U₁≤ . . . ≤Uᵢ≤ . . . ≤U_{K-1}.

In still another possible implementation, the method may further include: in the candidate data processing mode, determining that a lower probability limit of a current candidate data processing mode is the same as an upper probability limit of an adjacent candidate data processing mode, and determining that an upper probability limit of the current candidate data processing mode is the same as a lower probability limit of the adjacent candidate data processing mode.

In a specific embodiment, if the third preset value is different from the fourth preset value, it is determined that Lᵢ₋₁=Uᵢ; or if the third preset value is the same as the fourth preset value, it is determined that Uᵢ₋₁=Lᵢ.

In embodiments of this application, the upper probability limit and the lower probability limit in the candidate encoder are required to meet that: a lower probability limit of a current candidate encoder is the same as an upper probability limit of an adjacent candidate encoder, and an upper probability limit of the current candidate encoder is the same as a lower probability limit of the adjacent candidate encoder.

For example, if the update direction of the probabilities of the candidate encoder is opposite to the update direction of the index mapping table of the candidate encoder, Lᵢ₋₁ and Uᵢ are required to meet: Lᵢ₋₁=Uᵢ; or if the update direction of the probabilities of the candidate encoder is the same as the update direction of the index mapping table of the candidate encoder, Lᵢ₋₁ and Uᵢ are required to meet: Uᵢ₋₁=Lᵢ.

In other words, in embodiments of this application, high and low thresholds (that is, the upper probability limit and the lower probability limit) may be set for probability value update of different candidate data processing modes (one or more encoders).

For example, in this application, for K encoders used, an index value i thereof ranges from 0 to K−1. For each encoder, dual thresholds of probability update are set, including a low threshold Lᵢ and a high threshold Uᵢ, which are required to meet Lᵢ≤Uᵢ. An i^{th} encoder is used as an example. A probability value Pᵢ of the i^{th} encoder is constrained within an interval between the dual thresholds, and Pᵢ=Clip3(Lᵢ, Uᵢ, Pᵢ), where Clip3(x, y, z) is a clipping calculation function as shown in a formula (11).

In which, i=0, 1, 2, . . . , K−1, where K denotes a quantity of candidate data processing modes.

During encoding of a binary symbol (to-be-encoded syntax element), when both a probability value Pᵢ of the encoder and a corresponding index i in the mapping table increase (or remain unchanged), it is determined that an update direction of probabilities of the encoder is the same as an update direction of the index mapping table; otherwise, it is determined that the update direction of the probabilities of the encoder is opposite to the update direction of the index mapping table.

If the update direction of the probabilities of the encoder is opposite to the update direction of the index mapping table, the following is required to be met: L₀≥L₁≥ . . . ≥Lᵢ≥ . . . ≥L_{K-2}≥L_{K-1}, U₀≥U₁≥ . . . ≥Uᵢ≥ . . . ≥U_{K-2}≥U_{K-1}, Lᵢ=Uᵢ₊₁ (0≤i≤K−2), Uᵢ=Lᵢ₋₁ (1≤i≤K).

If the update direction of the probabilities of the encoder is the same as the update direction of the index mapping table, the following is required to be met: L₀≤L₁≤ . . . ≤Lᵢ≤ . . . ≤L_{K-2}≤L_{K-1}, U₀≤U₁ . . . ≤Uᵢ≤ . . . U_{K-2}≤U_{K-1}, Uᵢ=Lᵢ₊₁ (0≤i≤K−2), Lᵢ=Uᵢ₋₁ (1≤i≤K).

For example, assuming that a probability value stored in the encoder is a probability value of the symbol “0” with 16-bit precision, and a value of K is 32, the update direction of probabilities of the encoder is opposite to the update direction of the index mapping table. Therefore, a low threshold Lᵢ and a high threshold Uᵢ meet: L₀≥L₁≥ . . . ≥Lᵢ≥ . . . ≥L_{K-2}≥L_{K-1} and U₀≥U₁≥ . . . ≥Uᵢ≥ . . . ≥U_{K-2}≥U_{K-1}. At the endpoints, Lᵢ=Uᵢ₊₁ (0≤i≤K−2), and Uᵢ=Lᵢ₋₁ (1≤i≤K). Initial values Lᵢ⁰, Uᵢ⁰ of a low threshold and a high threshold of K=32 encoders may be set as shown in Table 3.

For a specific process of setting the low threshold Lᵢ and the high threshold Uᵢ, reference may be made to Table 4.

That is, according to the foregoing Table 3, the low threshold Lᵢ is set to a second value in an i^{th} two-dimensional array, and the high threshold U; is set to a first value in the i^{th} two-dimensional array.

In step 202, a data processing mode parameter corresponding to a to-be-encoded syntax element is determined.

In step 203, a target data processing mode is determined based on the candidate data processing mode and the data processing mode parameter.

It should be noted that, in embodiments of this application, the to-be-encoded syntax element specifically refers to a syntax element to be encoded on an encoding side. The syntax element herein may be a symbol in binary arithmetic encoding, or may be any syntax element written into a bitstream, which is not limited herein.

It should be further noted that, in embodiments of this application, the data processing mode parameter specifically refers to an index value corresponding to the candidate data processing mode. In some embodiments, the process of determining the data processing mode parameter corresponding to the to-be-encoded syntax element may include: determining context information of the to-be-encoded syntax element; and determining the data processing mode parameter based on the context information and a preset mapping table.

It may be understood that, in embodiments of this application, the preset mapping table may be a mapping relationship look up table. On the encoding side, the preset mapping table may be a candidate encoder index mapping table.

Further, in some embodiments, the process of determining the data processing mode parameter based on the context information and the preset mapping table may include: determining a context state of the to-be-encoded syntax element based on the context information; and determining the data processing mode parameter based on the context state and the preset mapping table.

It should be noted that, in embodiments of this application, the preset mapping table may be used to represent a mapping relationship between the context state and the data processing mode parameter. For example, based on the preset mapping table, an index value of an encoder corresponding to any context state (context information) may be determined.

It should be further noted that, in embodiments of this application, the context information may be classified into primary information and secondary information depending on importance of the information. The primary information is not reduced, while the secondary information may be reduced. After a dynamic reduction process, context information that is retained forms a context state (denoted by D). For context state D, a counter N is provided to record a quantity of times a current state D has been accessed. If N is greater than a preset threshold, the dynamic reduction process is updated, that is, for a syntax element to be encoded subsequently, more secondary information forms a new context state D.

In this way, after the context state D is determined, the data processing mode parameter corresponding to the to-be-encoded syntax element may be determined according to the preset mapping table. The preset mapping table records a mapping relationship between a plurality of pairs of context states and data processing mode parameters, and there is also a correspondence between the data processing mode parameter and a data processing mode, so that the target data processing mode (namely, a target encoder) corresponding to the to-be-encoded syntax element can be determined.

Further, in some embodiments, the method may further include: updating the preset mapping table based on a value of the to-be-encoded syntax element.

In a specific embodiment, the process of updating the preset mapping table may include: reducing data processing mode parameters in the preset mapping table in a case that the value of the to-be-encoded syntax element is a fifth preset value; or increasing data processing mode parameters in the preset mapping table in a case that the value of the to-be-encoded syntax element is a sixth preset value.

It should be noted that, in embodiments of this application, the fifth preset value is different from the sixth preset value, and the fifth preset value and the sixth preset value may be in a parameter form, or may be in a digital form. Specifically, the to-be-encoded syntax element may be a parameter written in a profile (profile), or may be a value of a flag (flag), which is not specifically limited herein.

For example, the fifth preset value may be set to 1, and the sixth preset value may be set to 0. Alternatively, the fifth preset value may be set to 0, and the sixth preset value may be set to 1. Alternatively, the fifth preset value may be set to true, and the sixth preset value may be set to false. Alternatively, the fifth preset value may be set to false, and the sixth preset value may be set to true. In embodiments of this application, the fifth preset value is 0, and the sixth preset value is 1, which is not specifically limited.

It should be further noted that, in embodiments of this application, after one syntax element is encoded each time, the data processing mode parameter in the preset mapping table may be adjusted based on a value of the syntax element. For example, if a value of a syntax element currently to be encoded is 0, the data processing mode parameter may be reduced (or remain unchanged); or if a value of a syntax element currently to be encoded is 1, the data processing mode parameter may be increased (or remain unchanged), so as to update the preset mapping table.

In some embodiments, the encoder index mapping table (that is, the preset mapping table) provides a mapping relationship between a context state and an encoder index value. Based on the mapping table, an encoder index value that should be used by a to-be-encoded syntax element in any context state may be obtained. After one syntax element is encoded each time, the mapping relationship between a context state D and an encoder index value in the mapping table is adjusted based on an encoding result of the syntax element.

For example, the encoder index mapping table may store an 8-bit encoder index value. When a symbol currently to be encoded is “1”, the encoder index value is increased (or remains unchanged). When a symbol currently to be encoded is “0”, the encoder index value is reduced (or remains unchanged).

A specific update manner is as follows: stateVal denotes the encoder index value, CtxMap denotes the encoder index mapping table, ctxMapIdx denotes the context state D, and binVal denotes the symbol currently to be encoded. Herein, ctxMapTransition represents a query table, as shown in Table 1, which shows values of ctxMapTransition[i].

For example, a specific update process is described as follows:

```
stateVal = CtxMap[ctxMapIdx]
if (binVal)
  CtxMap[ctxMapIdx] += ctxMapTransition[(255−stateVal)>>4];
else
  CtxMap[ctxMapIdx] −= ctxMapTransition[stateVal>>4].
```

After stateVal is obtained, an encoder corresponding to the symbol (syntax element) currently to be encoded may be obtained. An encoder index value may be in a one-to-one correspondence with an encoder, or further mapping may be performed on the encoder index value, that is, a plurality of encoder index values may correspond to one encoder, so as to obtain a final encoder index value.

For example, a secondary mapping process may be added, that is, a binary encoder index value obtained is used as an intermediate value (an intermediate index value), and an actual index value may be further determined. For example, stateVal is required to be right shifted by two bits to obtain a final encoder index value.

In step 204, a value of the to-be-encoded syntax element is encoded based on the target data processing mode to obtain encoded bits, and the encoded bits are written into a bitstream.

It should be noted that, in embodiments of this application, after the target data processing mode (namely, the target encoder) is determined, the value of the to-be-encoded syntax element may be encoded based on the target data processing mode to obtain encoded bits, and the encoded bits are written into a bitstream.

It should be further noted that, in embodiments of this application, after the to-be-encoded syntax element is encoded, a probability value corresponding to the target encoder is further required to be determined and updated. Therefore, in some embodiments, the method may further include: determining a first probability value of the target data processing mode based on the value of the to-be-encoded syntax element; and updating the first probability value of the target data processing mode to determine a second probability value of the target data processing mode.

It should be noted that, in embodiments of this application, after the second probability value of the target data processing mode is obtained by updating, the second probability value of the target data processing mode may be modified, to determine a target probability value of the target data processing mode.

In some embodiments, the process of updating the first probability value of the target data processing mode to determine the second probability value of the target data processing mode may include: determining a second parameter corresponding to the target data processing mode; and updating the first probability value of the target data processing mode based on the second parameter and the value of the to-be-encoded syntax element, to determine the second probability value of the target data processing mode.

It should be understood that, in embodiments of this application, the second parameter corresponding to the target data processing mode may refer to a symbol (Symbol) corresponding to a probability value stored in the target encoder. For example, the second parameter may indicate a specific value such as 0 or 1; or the second parameter may indicate a symbol in binary arithmetic encoding, for example, a symbol of 0 or 1, which is not limited herein.

It should be further understood that, in embodiments of this application, after the to-be-encoded syntax element is encoded, if the probability value of the target encoder represents a probability of the second parameter, the probability value of the target encoder may be increased or reduced depending on data indicated by the second parameter.

In a possible implementation, the process of updating the first probability value of the target data processing mode based on the second parameter and the value of the to-be-encoded syntax element may include:
in a case that the second parameter indicates first data, and the value of the to-be-encoded syntax element is a fifth preset value, increasing the first probability value of the target data processing mode; or
in a case that the second parameter indicates first data, and the value of the to-be-encoded syntax element is a sixth preset value, reducing the first probability value of the target data processing mode.

Alternatively, in another possible implementation, the process of updating the first probability value of the target data processing mode based on the second parameter and the value of the to-be-encoded syntax element may include:
in a case that the second parameter indicates second data, and a symbol for the to-be-encoded syntax element is a fifth preset value, reducing the first probability value of the target data processing mode; or
in a case that the second parameter indicates second data, and a symbol for the to-be-encoded syntax element is a sixth preset value, increasing the first probability value of the target data processing mode.

For example, if the probability value of the target encoder represents a probability of the symbol “0”, when a syntax element currently to be encoded is 0, the probability value of the target encoder is increased (or remains unchanged); or when a syntax element currently to be encoded is 1, the probability value of the target encoder is reduced (or remains unchanged). If the probability value of the encoder represents a probability of the symbol “1”, when a syntax element currently to be encoded is 0, the probability value of the target encoder is reduced (or remains unchanged); or when a syntax element currently to be encoded is 0, the probability value of the target encoder is increased (or remains unchanged).

It should be noted that, in embodiments of this application, the process of updating the first probability value may include: increasing the first probability value based on a preset attenuation factor; or reducing the first probability value based on a preset attenuation factor.

For example, in embodiments of this application, assuming that a probability value of an encoder represents a probability of the symbol “0”; after the symbol “0” is encoded, the probability value of the encoder is increased (or remains unchanged); and after the symbol “1” is encoded, the probability value of the encoder is reduced (or remains unchanged). A manner in which the first probability value is updated may be as shown in the formula (9), where a denotes the attenuation factor.

It should be noted that, in embodiments of this application, the process of updating the first probability value may include: increasing the first probability value according to a first pre-stored look up table; or reducing the first probability value according to a first pre-stored look up table.

For example, in embodiments of this application, the first probability value may be updated using a look up table. If the probability is represented with 16-bit precision, the formula (9) may be approximately converted into the formula (10), where diracLut denotes the look up table, as shown in Table 2.

For example, in embodiments of this application, for K encoders used, an index value i thereof ranges from 0 to K−1. In an encoding process, the probability value Pᵢ of the target encoder is continuously updated with accumulation of binary symbols binVal (a value of the to-be-encoded syntax element) encoded. Assuming that a j^{th} update is being performed currently, a current probability value (the second probability value) is Pᵢ, and a probability value before the update (the first probability value) is Pᵢ^{j-1}. The algorithm shown in Table 5 may be used in the probability update process. In which, diracLut[ ] is shown in Table 2, that is, an adjustment value (update amplitude) for probability update may be quickly obtained by looking up Table 2.

It should be noted that, in embodiments of this application, the update amplitude ΔPᵢ^{j} used in the update process of the first probability value may be a fixed value or a dynamic value, and may be related to or independent of the index value i of the encoder, which is not specifically limited in this application.

Further, in some embodiments, the second probability value of the target data processing mode may be modified by using a threshold parameter of the target data processing mode, to determine the target probability value of the target data processing mode.

In a specific embodiment, the process of modifying the second probability value of the target data processing mode to determine the target probability value of the target data processing mode may include:
in a case that the second probability value is less than a lower probability limit of the target data processing mode, setting the target probability value to the lower probability limit of the target data processing mode;
in a case that the second probability value is greater than an upper probability limit of the target data processing mode, setting the target probability value to the upper probability limit of the target data processing mode; or
in a case that the second probability value is greater than or equal to a lower probability limit of the target data processing mode and less than or equal to an upper probability limit of the target data processing mode, setting the target probability value to the second probability value.

It should be noted that, in embodiments of this application, the second probability value of the target data processing mode may be denoted by Pᵢ. Thus, for Pᵢ, two thresholds may be set: an upper probability limit (a high threshold) Uᵢ and a lower probability limit (a low threshold) Lᵢ, and the two thresholds should meet Lᵢ≤Uᵢ.

For example, for K encoders used, an index value i thereof ranges from 0 to K−1. In an encoding process, the probability value Pᵢ of the target encoder is continuously updated with accumulation of binary symbols binVal (a value of the to-be-encoded syntax element) encoded. Assuming that a j^{th} update is being performed currently, a current probability value (the second probability value) is P), and a probability value before the update (the first probability value) is Pᵢ^{j-1}. After the update of the probability value is completed, the second probability value Pᵢ is modified based on a high threshold Uᵢ^{j-1} and a low threshold Lᵢ^{j-1} of an encoder i. For example, Pᵢ^{j}=Clip3(Lᵢ^{j-1}, Uᵢ^{j-1}, Pᵢ^{j}), where Clip3(x, y, z) is a clipping calculation function.

It should be noted that, in embodiments of this application, for an encoder k,(k∈[0,K], k≠i) other than the target encoder, a probability value Pₖ^{j} of the encoder k remains unchanged during this update, and Pₖ^{j}=Pₖ^{j-1}.

Further, in embodiments of this application, after the first probability value of the target data processing mode is updated to determine the corresponding second probability value, the threshold parameter of the target data processing mode may be adjusted based on the second probability value, to determine an adjusted threshold parameter.

That is, in embodiments of this application, the threshold parameter of the data processing mode may be dynamically adjusted. For example, high and low probability thresholds (a lower probability limit or an upper probability limit) of an encoder may be dynamically adjusted.

Further, in embodiments of this application, the process of adjusting the threshold parameter of the target data processing mode based on the second probability value to determine the adjusted threshold parameter may include: if the second probability value is less than the lower probability limit of the target data processing mode, reducing the lower probability limit of the target data processing mode to determine an adjusted lower probability limit; and determining the adjusted threshold parameter based on the adjusted lower probability limit and the upper probability limit of the target data processing mode.

Further, in embodiments of this application, the process of adjusting the threshold parameter of the target data processing mode based on the second probability value to determine the adjusted threshold parameter may include: if the second probability value is greater than the upper probability limit of the target data processing mode, increasing the upper probability limit of the target data processing mode to determine an adjusted upper probability limit; and determining the adjusted threshold parameter based on the adjusted upper probability limit and the lower probability limit of the target data processing mode.

In other words, in embodiments of this application, the process of adjusting the threshold parameter of the target data processing mode may include: increasing the upper probability limit of the target data processing mode and forming the adjusted threshold parameter by the lower probability limit before the adjustment and the adjusted upper probability limit; or reducing the lower probability limit of the target data processing mode, and forming the adjusted threshold parameter by the upper probability limit before the adjustment and the adjusted lower probability limit.

Further, in embodiments of this application, the process of adjusting the threshold parameter of the target data processing mode may include: determining adjustment amplitude according to a second pre-stored look up table (such as Table 6), where the adjustment amplitude is used to increase the upper probability limit, or reduce the lower probability limit; and adjusting the threshold parameter of the target data processing mode based on the adjustment amplitude.

It should be noted that, in embodiments of this application, during adjustment of the threshold parameter of the target data processing mode, the selected adjustment amplitude may include ΔUᵢ^{j} for increasing the upper probability limit, or may include ΔLᵢ^{j} for reducing the lower probability limit, where the adjustment amplitudes ΔUᵢ^{j} and ΔLᵢ^{j} may be identical, and may be fixed values, or may be values dynamically changing with the index value i of the encoder. The value of the adjustment amplitude is not limited in this application.

For example, in embodiments of this application, the process of dynamically adjusting high and low probability thresholds Uᵢ and Lᵢ of the encoder i may include: adjusting the high and low thresholds of the encoder based on the updated second probability value Pᵢ^{j} of the encoder i, referring to the formula (12).

If the updated second probability value of the encoder i is greater than a high threshold Uᵢ^{j-1} of the encoder i before update, the high threshold is increased, for example, ΔUᵢ^{j} is added to the high threshold Uᵢ^{j-1}. If the updated probability value of the encoder i is less than a low threshold Lᵢ^{j-1} of the encoder i before update, the low threshold is reduced, for example, A is subtracted from the low threshold Lᵢ^{j-1}. If the updated probability value of the encoder i is within a probability interval [Lᵢ^{j-1}, Uᵢ^{j-1}] of the encoder i before update, the high and low thresholds are not adjusted.

For example, in embodiments of this application, values of adjustment amplitudes ΔUᵢ^{j} and ΔLᵢ^{j} may be determined jointly based on a probLut jump table containing 256 values shown in Table 6 and first eight bits of a current probability value (with 16-bit precision), referring to the formula (13).

Further, in embodiments of this application, the adjusted threshold parameter is modified to determine that an adjusted lower probability limit of the target data processing mode is the same as an upper probability limit of an adjacent candidate data processing mode, or determine that an adjusted upper probability limit of the target data processing mode is the same as a lower probability limit of an adjacent candidate data processing mode.

It should be noted that, in embodiments of this application, after the threshold parameter of the target data processing mode is adjusted, if the lower probability limit is reduced, it is required to ensure that the adjusted lower probability limit of the target data processing mode is the same as the upper probability limit of the adjacent candidate data processing mode; or if the upper probability limit is increased, it is required to ensure that the adjusted upper probability limit of the target data processing mode is the same as the lower probability limit of the adjacent candidate data processing mode.

In other words, in embodiments of this application, both an upper probability limit and a lower probability limit for the encoder may be dynamically updated and adjusted, as long as an updated upper probability limit and an updated lower probability limit can still meet: L₀≥L₁≥ . . . ≥Lᵢ≥ . . . ≥L_{K-1} and U₀≥U₁≥ . . . ≥Uᵢ≥ . . . ≥U_{K-1}; or L₀≤L₁≤ . . . ≤Lᵢ≤ . . . ≤L_{K-1} and U₀≤U₁≤ . . . ≤Uᵢ≤ . . . ≤U_{K-1}.

For example, in embodiments of this application, it is required to ensure that probability intervals of encoders do not overlap after the high and low thresholds are adjusted. When the update direction of probabilities of the encoder is opposite to the update direction of the index mapping table, if an adjusted high threshold Uᵢ^{j} is greater than a high threshold Uᵢ₋₁^{j} of an adjacent encoder, the high threshold Uᵢ^{j} is modified to Uᵢ₋₁^{j} (1≤i≤K); or if an adjusted low threshold L is less than a low threshold Lᵢ₊₁^{j} of an adjacent encoder, the low threshold L) is modified to Lᵢ₊₁^{j} (0≤i≤K−2), specifically referring to formulas (14) and (15).

Further, in embodiments of this application, update amplitude used for updating the first probability value of the target data processing mode is greater than the adjustment amplitude used for adjusting the threshold parameter of the target data processing mode.

In other words, in embodiments of this application, amplitude for updating the probability value of the target data processing mode is greater than amplitude for adjusting the threshold parameter of the target data processing mode, that is, the probability value of the target data processing mode is mainly updated, while the threshold parameter of the target data processing mode is slightly adjusted, that is, the adjustment amplitude should not be greater than the update amplitude for the probability value.

For example, in embodiments of this application, adjustment amplitude values ΔUᵢ^{j} and ΔLᵢ^{j} of high and low probability thresholds may be identical, and may be fixed values or values dynamically changing with the encoder index value i. In a j^{th} update process, both ΔUᵢ^{j} and ΔLᵢ^{j} are less than amplitude (update amplitude) for updating the probability value.

For example, in embodiments of this application, assuming that an update direction of probabilities of encoders (0 to K−1) is opposite to an update direction of the index mapping table, for a specific process of dynamically adjusting dual probability thresholds of the encoder i, reference may be made to Table 9.

TABLE 9
Dynamic_Adjustment ( ):

| | |
|---|---|
| for j←o to N : | // N denotes a quantity of times |
| | of probability updates |
| Pᵢ^{j} ←Update_probability | // update a probability value |
| (Pᵢ^{j-1}) | of an encoder |

i
if Pᵢ^{j}> Uᵢ^{j-1}:

| | |
|---|---|
| Pᵢ^{j} ←Uᵢ^{j-1} | // modify an updated probability value |
| Uᵢ^{j} += ΔUᵢ^{j} | // dynamically adjust a high threshold |
| | of the encoder i |

```
  if i > 0 && Uᵢ^{j}> Uᵢ₋₁^{j}:
  Uᵢ^{j} = Uᵢ₋₁^{j}
```

| | |
|---|---|
| Lᵢ₊₁^{j} ← Uᵢ^{j} | // adjust a low threshold of an encoder i+1 |

else if Pᵢ^{j} < Lᵢ^{j-1}:

| | |
|---|---|
| Pᵢ^{j} ← Lᵢ^{j-1} | // modify an updated probability value |
| Lᵢ^{j} −= ΔLᵢ^{j} | // dynamically adjust a low threshold |

```
  if i < K−1 && Lᵢ^{j} < Lᵢ₊₁^{j}:
  Lᵢ^{j} = Lᵢ₊₁^{j}
```

| | |
|---|---|
| Uᵢ₋₁^{j} ← Lᵢ^{j} | // adjust a high threshold of an encoder i−1 |

return Pᵢ^{j}, Lᵢ^{j}, Uᵢ^{j}

After the first probability value Pᵢ^{j-1} of the encoder i is updated to the second probability value Pᵢ^{j}, Pᵢ^{j} may be modified.

In a modification process, if Pᵢ^{j} is greater than a corresponding upper probability limit Uᵢ^{j-1}, Pᵢ^{j} is modified to Uᵢ^{j-1} and a high threshold Uᵢ^{j-1} of the encoder i is dynamically adjusted, for example, the high threshold is increased using amplitude ΔUᵢ^{j}. If an adjusted upper probability limit Uᵢ^{j} is greater than an upper probability limit Uᵢ₋₁^{j} of an adjacent encoder, a low threshold Lᵢ₊₁^{j} of an encoder i+1 may be further adjusted to Uᵢ^{j}.

In a modification process, if Pᵢ^{j} is greater than a corresponding lower probability limit Lᵢ^{j-1}, Pᵢ^{j} is modified to Lᵢ^{j-1}, and a low threshold Lᵢ^{j-1} of the encoder i is dynamically adjusted to Uᵢ^{j}, for example, the low threshold is reduced using amplitude ΔLᵢ^{j}. If an adjusted lower probability limit Lᵢ^{j} is less than a lower probability limit Lᵢ₊₁^{j} of an adjacent encoder, a high threshold Uᵢ₋₁^{j} of an encoder i−1 may be further adjusted to Lᵢ^{j}.

Further, in embodiments of this application, the second probability value of the target data processing mode may be first modified, and the threshold parameter of the target data processing mode may be then adjusted based on the second probability value, to obtain the adjusted threshold parameter. Alternatively, the threshold parameter of the target data processing mode may be first adjusted based on the second probability value, to determine the adjusted threshold parameter, and the second probability value may be then modified based on the adjusted threshold parameter, to determine the target probability value of the target data processing mode.

In other words, in embodiments of this application, the corresponding second probability value may be modified by using the threshold parameter of the target data processing mode before adjustment, or the corresponding second probability value may be modified by using the adjusted threshold parameter of the target data processing mode. The modification manner is not limited in this application.

For example, in embodiments of this application, after the value of the to-be-encoded syntax element is determined, the first probability value of the target data processing mode may be first determined based on the value of the to-be-encoded syntax element. Then, the first probability value of the target data processing mode may be updated, to determine the second probability value of the target data processing mode. Next, the threshold parameter of the target data processing mode may be adjusted based on the second probability value, to determine the adjusted threshold parameter. Finally, the second probability value may be modified based on the adjusted threshold parameter, to determine the target probability value of the target data processing mode.

As described above, according to the encoding method described in steps 201 to 204, a corresponding upper probability limit and a corresponding lower probability limit may be set for each of different candidate encoders, where the upper probability limit and the lower probability limit may be dynamically adjusted in an encoding process. In addition, a probability value of an encoder may also be dynamically adjusted, and during adjustment, the probability value may be constrained and modified by using a corresponding upper probability limit and a corresponding lower probability limit.

For example, FIG. 13 is a schematic diagram 2 of implementation of a dynamic adjustment scheme according to this application. As shown in FIG. 13, an initial probability value Pᵢ⁰ and corresponding high and low thresholds Uᵢ⁰ and Lᵢ⁰ of a candidate encoder (candidate data processing mode) may be first initialized based on a first preset condition. After an encoder index (data processing mode parameter) corresponding to a to-be-encoded syntax element is determined based on a context state, a value (binVal) of the to-be-encoded syntax element may be encoded by using a target encoder (target data processing mode) indicated by the encoder index. Then, a probability value of the corresponding target encoder may be updated based on the value of the to-be-encoded syntax element, to obtain a second probability value. Finally, both the second probability value and the high and low thresholds may be dynamically adjusted.

It may be understood that, in embodiments of this application, the initial probability value of the candidate encoder (candidate data processing mode) may also be set based on the first preset condition. The initial probability value of the candidate encoder that is determined based on the first preset condition may be any value within a range between the corresponding upper probability limit and the corresponding lower probability limit.

Further, in embodiments of this application, in the dynamic adjustment portion in FIG. 11, the process of dynamically adjusting the second probability value and the high and low thresholds may include: adjusting corresponding threshold parameters (the high and low thresholds) based on a second probability value obtained by updating, to determine adjusted threshold parameters, and modifying the second probability value based on the adjusted threshold parameters, to obtain a modified target probability value; or modifying a second probability value obtained by updating based on the threshold parameters, to obtain a modified target probability value, and adjusting the corresponding threshold parameters based on the second probability value, to determine adjusted threshold parameters.

It should be noted that, in embodiments of this application, compared with a related technology, octree geometry encoding bitstream performance under lossless conditions achieved by using the encoding method provided in embodiments of this application is as shown in Table 8.

It may be learned that, the encoding method provided in embodiments of this application achieves an average gain of about 1.4% on the geometric bitstream of these data, thereby reducing encoding bits.

Further, an embodiment of this application further provides a bitstream, where the bitstream is generated by performing bit encoding on to-be-encoded information; and the to-be-encoded information at least includes a value of a to-be-encoded syntax element.

It should be further noted that, in embodiments of this application, the to-be-encoded syntax element may be encoded on an encoding side and written into the bitstream. Subsequently, the value of the syntax element may be determined by decoding on a decoding side, so that a related decoding operation is executed on the decoding side by using the value of the syntax element.

This embodiment provides an encoding method. In which, a candidate data processing mode is determined by an encoder based on a first preset condition; a data processing mode parameter corresponding to a to-be-encoded syntax element is determined; a target data processing mode is determined based on the candidate data processing mode and the data processing mode parameter; and a value of the to-be-encoded syntax element is encoded based on the target data processing mode to obtain encoded bits, and the encoded bits are written into a bitstream. It may be learned that in embodiments of this application, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

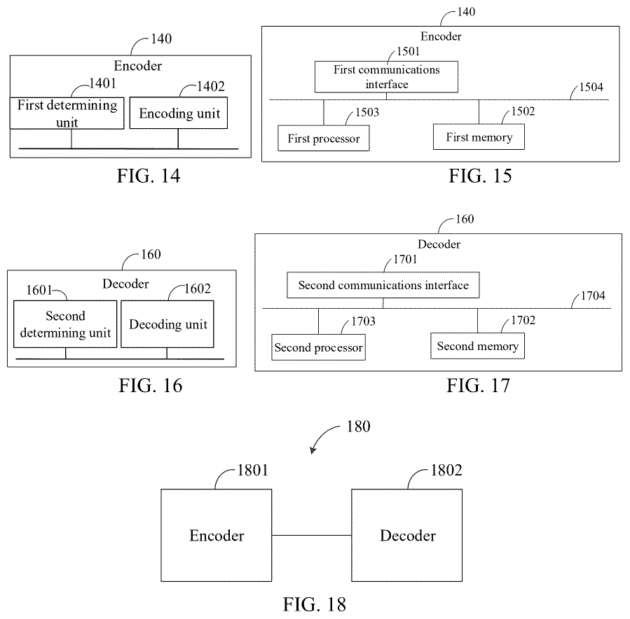

Based on a same invention concept of foregoing embodiments, FIG. 14 is a schematic diagram of a structure of an encoder 140 according to an embodiment of this application. As shown in FIG. 14, the encoder 140 may include a first determining unit 1401 and an encoding unit 1402.

The first determining unit 1401 is configured to determine a candidate data processing mode based on a first preset condition; and determine a data processing mode parameter corresponding to a to-be-encoded syntax element.

The first determining unit 1401 is further configured to determine a target data processing mode based on the candidate data processing mode and the data processing mode parameter.

The encoding unit 1402 is configured to encode a value of the to-be-encoded syntax element based on the target data processing mode to obtain encoded bits, and write the encoded bits into a bitstream.

It should be noted that, in embodiments of this application, the encoder 140 may also be considered as a data processing mode (or “entropy encoder”), and is configured to encode the value of the to-be-encoded syntax element.

It may be understood that, in embodiments of this application, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or a part of the technical solutions may be implemented in a form of a software product. The computer software product is stored in a storage medium and includes several instructions for instructing a computer device (which may be a personal computer, a server, or a network device) or a processor to execute all or a part of the steps of the methods described in the embodiments. The foregoing storage medium includes various media that may store a program code, such as a USB flash drive, a removable hard disk, a read-only memory (ROM), a random access memory (RAM), a magnetic disk, or an optical disk.

Therefore, an embodiment of this application provides a computer-readable storage medium, applied to the encoder 140. The computer-readable storage medium stores a computer program, and the computer program is executed by a first processor to implement the encoding method in any one of the foregoing embodiments.

Based on the composition of the encoder 140 and the computer-readable storage medium, referring to FIG. 15, FIG. 15 is a schematic diagram of a structure of specific hardware of the encoder 140 according to an embodiment of this application. As shown in FIG. 15, the encoder 140 may include a first communications interface 1501, a first memory 1502, and a first processor 1503. The components are coupled together by using a first bus system 1504. It may be understood that the first bus system 1504 is configured to implement connection and communication between these components. The first bus system 1504 may further include a power bus, a control bus, a status signal bus, and the like, in addition to a data bus. However, for clarity of description, various buses are marked as the first bus system 1504 in FIG. 15.

The first communications interface 1501 is configured to receive and transmit signals in the process of transmitting and receiving information with other external network elements.

The first memory 1502 is configured to store a computer program runnable on the first processor 1503.

The first processor 1503 is configured to run the computer program to perform the following operations:
determining a candidate data processing mode based on a first preset condition;
determining a data processing mode parameter corresponding to a to-be-encoded syntax element;
determining a target data processing mode based on the candidate data processing mode and the data processing mode parameter; and
encoding a value of the to-be-encoded syntax element based on the target data processing mode to obtain encoded bits, and writing the encoded bits into a bitstream.

It may be understood that, in embodiments of this application, the first memory 1502 may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 1502 in the systems and the methods described in this application includes but is not limited to these and any memory of another appropriate type.

However, the first processor 1503 may be an integrated circuit chip and has a signal processing capability. In an implementation process, steps in the foregoing method can be implemented by using a hardware integrated logical circuit in the first processor 1503, or by using instructions in a form of software. The first processor 1503 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in the first memory 1502, and the first processor 1503 reads information in the first memory 1502 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (ASIC), digital signal processors (DSP), digital signal processing devices (DSP Device, DSPD), programmable logic devices (PLD), field programmable gate arrays (FPGA), general-purpose processors, controllers, microcontrollers, microprocessors, and other electronic units configured to perform the functions described in this application, or a combination thereof. For software implementation, the techniques described in this application can be implemented by modules (e.g., processes, functions, etc.) that perform the functions described in this application. Software code may be stored in a memory and executed by a processor. The memory can be implemented in or outside the processor.

Optionally, in another embodiment, the first processor 1503 is further configured to run the computer program to perform the encoding method according to any one of the foregoing embodiments.

This embodiment provides an encoder. In which, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

Based on a same invention concept of foregoing embodiments, FIG. 16 is a schematic diagram of a structure of a decoder 160 according to an embodiment of this application. As shown in FIG. 16, the decoder 160 may include a second determining unit 1601 and a decoding unit 1602.

The second determining unit 1601 is configured to: determine a candidate data processing mode based on a first preset condition, and determine a data processing mode parameter corresponding to a to-be-decoded syntax element.

The second determining unit 1601 is further configured to determine a target data processing mode based on the candidate data processing mode and the data processing mode parameter.

The decoding unit 1602 is configured to decode the to-be-decoded syntax element based on the target data processing mode, to determine a value of the to-be-decoded syntax element.

It should be noted that, in embodiments of this application, the decoder 160 may also be considered as a data processing mode (or “entropy decoder”), and is configured to decode the value of the to-be-decoded syntax element.

It may be understood that in embodiments, the term “unit” may be a partial circuit, a partial processor, a partial program or software, or the like. Certainly, the term “unit” may be a module or may be in a non-modular form. In addition, component parts in embodiments may be integrated into one processing unit, or each of the units may exist alone physically, or two or more units may be integrated into one unit. The integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment of this application provides a computer-readable storage medium, applied to a decoder 160. The computer-readable storage medium stores a computer program, and the computer program is executed by a second processor to implement the method according to any one of the foregoing embodiments.

Based on the composition of the decoder 160 and the computer-readable storage medium, referring to FIG. 17, FIG. 17 is a schematic diagram of a structure of specific hardware of the decoder 160 according to an embodiment of this application. As shown in FIG. 17, the decoder 160 may include a second communications interface 1701, a second memory 1702, and a second processor 1703. The components are coupled together by using a second bus system 1704. It may be understood that the second bus system 1704 is configured to implement connection and communication between these components. The second bus system 1704 may further include a power bus, a control bus, a status signal bus, and the like, in addition to a data bus. However, for clarity of description, various buses are marked as the second bus system 1704 in FIG. 17.

The second communications interface 1701 is configured to receive and transmit a signal in a process of transmitting and receiving information between the second communications interface and another external network element.

The second memory 1702 is configured to store a computer program runnable on the second processor 1703.

The second processor 1703 is configured to run the computer program to perform the following operations:
determining a candidate data processing mode based on a first preset condition;
determining a data processing mode parameter corresponding to a to-be-decoded syntax element;
determining a target data processing mode based on the candidate data processing mode and the data processing mode parameter; and
decoding the to-be-decoded syntax element based on the target data processing mode, to determine a value of the to-be-decoded syntax element.

Optionally, in another embodiment, the second processor 1703 is further configured to run the computer program to perform the method according to any one of the foregoing embodiments.

It may be understood that hardware functions of the second memory 1702 are similar to those of the first memory 1502, and hardware functions of the second processor 1703 are similar to those of the first processor 1503, which is not detailed here.

This embodiment provides a decoder. In which, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

Referring to FIG. 18, FIG. 18 is a schematic diagram of a structure of a coding system according to an embodiment of this application. As shown in FIG. 18, the coding system 180 may include an encoder 1801 and a decoder 1802.

In this embodiment of this application, the encoder 1801 may be the encoder according to any one of the foregoing embodiments, and the decoder 1802 may be the decoder according to any one of the foregoing embodiments.

It should be noted that in this application, the terminology “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a . . . ” does not exclude the existence of other identical elements in the process, method, item or device including this element.

The sequence numbers of the embodiments of this application are only for description, and do not represent superiority or inferiority of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL APPLICABILITY

Embodiments of this application provide a coding method, a bitstream, an encoder, a decoder, and a storage medium. On an encoding side, a candidate data processing mode is determined based on a first preset condition; a data processing mode parameter corresponding to a to-be-encoded syntax element is determined; a target data processing mode is determined based on the candidate data processing mode and the data processing mode parameter; and a value of the to-be-encoded syntax element is encoded based on the target data processing mode to obtain encoded bits, and the encoded bits are written into a bitstream. On a decoding side, a candidate data processing mode is determined based on a first preset condition; a data processing mode parameter corresponding to a to-be-decoded syntax element is determined; a target data processing mode is determined based on the candidate data processing mode and the data processing mode parameter; and the to-be-decoded syntax element is decoded based on the target data processing mode, to determine a value of the to-be-decoded syntax element. It may be learned that in embodiments of this application, a corresponding data processing mode parameter may be determined based on a to-be-processed syntax element, and a target data processing mode may be further determined from candidate data processing modes, and finally, the syntax element may be encoded or decoded based on the target data processing mode. The candidate data processing mode is determined based on the first preset condition, so that an optimal target encoder can be selected from candidate data processing modes for encoding in an encoding process, and therefore a most matched data processing mode can be selected in a coding process, thereby improving coding performance.

What is claimed is:

1. A decoding method, applied to a decoder, wherein the method comprises:
determining a candidate data processing mode;
determining a data processing mode parameter corresponding to a to-be-decoded syntax element;
determining a target data processing mode based on the candidate data processing mode and the data processing mode parameter; and
decoding the to-be-decoded syntax element based on the target data processing mode, to determine a value of the to-be-decoded syntax element.

2. The method according to claim 1, wherein the determining the candidate data processing mode comprises:
determining a threshold parameter of the candidate data processing mode based on a first preset condition.

3. The method according to claim 2, wherein the threshold parameter indicates a probability threshold of the candidate data processing mode, and the probability threshold comprises an upper probability limit and/or a lower probability limit.

4. The method according to claim 1, wherein
a lower probability limit of a current candidate data processing mode is the same as an upper probability limit of an adjacent candidate data processing mode, and an upper probability limit of the current candidate data processing mode is the same as a lower probability limit of the adjacent candidate data processing mode.

5. The method according to claim 1, further comprising:
determining a first probability value of the target data processing mode based on the value of the to-be-decoded syntax element; and
updating the first probability value of the target data processing mode to determine a second probability value of the target data processing mode.

6. The method according to claim 5, further comprising:
modifying the second probability value of the target data processing mode to determine a target probability value of the target data processing mode.

7. The method according to claim 5, wherein the updating the first probability value of the target data processing mode to determine the second probability value of the target data processing mode comprises:
determining a second parameter corresponding to the target data processing mode; and
updating the first probability value of the target data processing mode based on the second parameter and the value of the to-be-decoded syntax element, to determine the second probability value of the target data processing mode.

8. The method according to claim 7, wherein the updating the first probability value of the target data processing mode based on the second parameter and the value of the to-be-decoded syntax element comprises:
in a case that the second parameter indicates first data, and the value of the to-be-decoded syntax element is a fifth preset value, increasing the first probability value of the target data processing mode; or
in a case that the second parameter indicates first data, and the value of the to-be-decoded syntax element is a sixth preset value, reducing the first probability value of the target data processing mode.

9. The method according to claim 8, further comprising:
increasing the first probability value according to a first pre-stored look up table; or
reducing the first probability value according to a first pre-stored look up table.

10. The method according to claim 6, wherein the modifying the second probability value of the target data processing mode to determine the target probability value of the target data processing mode comprises:
in a case that the second probability value is less than a lower probability limit of the target data processing mode, setting the target probability value to the lower probability limit of the target data processing mode;
in a case that the second probability value is greater than an upper probability limit of the target data processing mode, setting the target probability value to the upper probability limit of the target data processing mode; or
in a case that the second probability value is greater than or equal to a lower probability limit of the target data process mode and less than or equal to an upper probability limit of the target data process mode, setting the target probability value to the second probability value.

11. The method according to claim 5, further comprising:
adjusting a threshold parameter of the target data processing mode based on the second probability value, to determine an adjusted threshold parameter;
wherein the adjusting the threshold parameter of the target data processing mode based on the second probability value, to determine the adjusted threshold parameter comprises:
in a case that the second probability value is less than a lower probability limit of the target data processing mode, reducing the lower probability limit of the target data processing mode to determine an adjusted lower probability limit; and
determining an adjusted threshold parameter based on the adjusted lower probability limit and an upper probability limit of the target data processing mode;
or
wherein the adjusting the threshold parameter of the target data processing mode based on the second probability value, to determine the adjusted threshold parameter comprises:
in a case that the second probability value is greater than an upper probability limit of the target data processing mode, increasing the upper probability limit of the target data processing mode to determine an adjusted upper probability limit; and
determining an adjusted threshold parameter based on the adjusted upper probability limit and a lower probability limit of the target data processing mode.

12. The method according to claim 11, further comprising:
determining adjustment amplitude according to a second pre-stored look up table, wherein the adjustment amplitude is used to increase the upper probability limit, or reduce the lower probability limit; and
adjusting the threshold parameter of the target data processing mode according to the adjustment amplitude.

13. The method according to claim 1, wherein the determining the data processing mode parameter corresponding to the to-be-decoded syntax element comprises:
determining context information of the to-be-decoded syntax element; and
determining the data processing mode parameter based on the context information and a preset mapping table;
wherein the determining the data processing mode parameter based on the context information and the preset mapping table comprises:
determining a context state of the to-be-decoded syntax element based on the context information; and
determining the data processing mode parameter based on the context state and the preset mapping table,
wherein the preset mapping table is used to represent a mapping relationship between the context state and the data processing mode parameter.

14. The method according to claim 13, further comprising:
updating the preset mapping table based on the value of the to-be-decoded syntax element; and
in a case that the value of the to-be-decoded syntax element is a fifth preset value, reducing the target data processing mode parameter in the preset mapping table; or
in a case that the value of the to-be-decoded syntax element is a sixth preset value, increasing the target data processing mode parameter in the preset mapping table.

15. An encoder, wherein the encoder comprises a memory and a processor, wherein the memory is configured to store a computer program, and the processor is configured to execute the computer program stored in the memory to cause the encoder to perform operations comprising:
determining a candidate data processing mode, and determining a data processing mode parameter corresponding to a to-be-encoded syntax element;
determining a target data processing mode based on the candidate data processing mode and the data processing mode parameter; and
encoding a value of the to-be-encoded syntax element based on the target data processing mode to obtain encoded bits, and writing the encoded bits into a bitstream.

16. A decoder, wherein the decoder comprises a memory and a processor, wherein the memory is configured to store a computer program, and the processor is configured to execute the computer program stored in the memory to cause the decoder to perform operations comprising:
determining a candidate data processing mode, and determining a data processing mode parameter corresponding to a to-be-decoded syntax element;
determining a target data processing mode based on the candidate data processing mode and the data processing mode parameter; and
decoding the to-be-decoded syntax element based on the target data processing mode, to determine a value of the to-be-decoded syntax element.

17. The decoder according to claim 16, wherein for determining the candidate data processing mode, the decoder is further configured to:
determine a threshold parameter of the candidate data processing mode based on a first preset condition.

18. The decoder according to claim 17, wherein the threshold parameter indicates a probability threshold of the candidate data processing mode, and the probability threshold comprises an upper probability limit and/or a lower probability limit.

19. The decoder according to claim 16, wherein a lower probability limit of a current candidate data processing mode is the same as an upper probability limit of an adjacent candidate data processing mode, and an upper probability limit of the current candidate data processing mode is the same as a lower probability limit of the adjacent candidate data processing mode.

20. The decoder according to claim 16, wherein the decoder is further configured to:
determine a first probability value of the target data processing mode based on the value of the to-be-decoded syntax element; and
update the first probability value of the target data processing mode to determine a second probability value of the target data processing mode.
